(19) United States
(12) Patent Application Publication
(10) Pub. No.: US 2004/0200119 A1
(43) Pub. Date: Oct. 14, 2004

(54) Cast net with throwing device

(76) Inventor: Paul C. Ardern, Riviera Beach, FL (US)

Correspondence Address: PAUL C. ARDERN, 133 EAST 21st STREET, RIVIERA BEACH, FL, 33404, US

(21) Appl. No.: 10/794,033

(22) Filed: Mar. 4, 2004

Related U.S. Application Data
(63) Continuation-in-part of application No. 10/286,546, filed on Nov. 1, 2002, now abandoned.
Application No. 10/286,546 is a continuation-in-part of application No. 09/641,779, filed on Aug. 18, 2000, now Pat. No. 6,474,012.

(51) Int. Cl. A01K 73/00

(52) U.S. Cl. 43/8

(57) ABSTRACT

A cast net throwing device is provided for use with a cast net including a netting defining a mesh, with the netting being bounded at an outer periphery by a lead line, and the cast net that may including a plurality of brail lines secured at opposite end to the lead line and interconnected there between to a throw line, with the throw line and brail lines operating in combination with one another to close the net when a user pulls on the throw line. The cast net throwing device comprises at least one handle member having apertures for accepting brail lines, (throwing device) operatively secured to the central area of the netting intermediate the lead line, without interfering with the function of the brail lines of the cast net. The handle member is sized and configured to permit a user to grasp the member, thereby enhancing the user's ability to impart rotation to the cast net when the cast net is thrown. This enhancement is effective because mechanical advantages are imparted to the throwing process, and therefore the opening of the net during the throwing process is enhanced as a result of additional centrifugal force being applied to the net opening process as well as a sequential engagement of force due to varying radii about the axes of rotation. It is preferred that the throwing device be a circular ring.

### RELATED APPLICATIONS

This Application is a continuation in part Application of a continuation in part application Ser. No. 10/286,546 filed Oct. 31, 2002 which is a continuation in part of application Ser. No. 09/641,779 filed Aug. 18, 2000.

### FIELD OF THE INVENTION

The present invention relates generally to cast nets and more particularly to a cast net that incorporates a throwing device that will assist in the task of throwing a cast net.

### BACKGROUND OF THE INVENTION

A cast net is a generally circular net which is hand thrown by an individual in a plane which is generally parallel with the surface of a body of water. The cast net is an ancient invention having been used for thousands of years. Cast nets, as nets go, are very small in that they must be thrown by a human. Cast nets vary in size from about 6 to about 24 feet in diameter. Regardless of this diameter, cast nets are described by the radius of the net, i.e. a net with an 8-foot diameter is referred to as a 4 foot net.

The purpose of a cast net is catch aquatic creatures i.e. bait fish, shrimp, eels etc. The description hereinafter will refer to the capture of baitfish. Because of its relatively small size, cast nets are usually used on concentrations of fish, for example a school of baitfish. While an experienced person can throw a cast net well, the ability to properly throw a cast net is a skill that is not easily acquired.

The throwing of a typical cast net is difficult, if the cast net is not properly thrown the net will not open in an appropriate circular pattern and hence the net will not entrap the desired target. That is, if the net does not open, the surface area encompassed by the net drop will be minimal hence the number of baitfish caught will be small if any.

The ability to properly throw a cast net is not easily acquired. This ability is particularly difficult to acquire for a casual user of a cast net. To properly throw a cast net, the user must impart both a planar and circular motion to the net in a precise manner. The planar motion carries the net out and away from the user. The circular motion is necessary in order to apply centrifugal force to the outer circumference of the net in order to pull the airborne net open in a circular pattern. This complex action must be carried out in a fraction of a second as once the net contacts the water, the disposition of the net will not change. Upon striking the water, the cast net is pulled down by integral weights thereby entrapping any baitfish as may be under the pattern of the net drop.

While it is easy to impart planar motion to a cast net, it is difficult to simultaneously impart circular motion. The ability to impart both planar and circular motion to a cast net is particularly difficult for amateur casual users of cast nets.

In the last decade, the use of natural live baitfish in sport fishing has grown dramatically. Most of the baitfish caught for this type of fishing are caught with cast nets. In order to be effective, the baitfish used in sport fishing should be as lively as possible. In order for baitfish to be lively, it is best if they are caught just prior to the time when the fishing for the desired species occurs. This usually means the baitfish must be caught in the venue where the fishing will occur, by the fisherman who is often not proficient in the art of throwing a cast net. Anything which will aid a fisherman in throwing a cast net is a welcome addition to the art.

Innovations in the cast net art have been very small over the last two thousand years. Originally cast nets were oblong in shape, the periphery of which was weighted with stones. The most important addition to the cast net art was the unpatented improvement involving the addition of brail lines around 1000 AD. The function of these brail lines will be described in greater detail herein below.

One of the earliest known throwing devices for a cast net was the subject of U.S. Pat. No. 876,148, wherein a boat was rigged with a crane-like arm that suspended a cast net sized ring. The ring, being the same diameter as the net, was rigged with a series of pins for hanging the net in wide open configuration; at the desired moment the fisherman would pull the pins via attached pull chords, thus releasing the net. While this invention was effective, it required a large boat, and took a long time to re-rig.

By 1986, a separate disc like device, into which the cast net was loaded, became available. When the disc is flung in a radial fashion the cast net leaves the disc with a planar and circular motion. This prior art disc device is the subject of U.S. Pat. No. 4,607,448. While this disc device was an advance in the art it has not proved to be successful as the device is complicated and time consuming to load and it is a separate part that can be lost. Further in order to be effective the net must be properly and carefully loaded into the disc. While the precise loading is possible on dry land, it is extremely difficult or impossible if the user is wading or confined to a small boat. Compared to the above described prior art disc device, the device of this invention is advantageous in that it is integral with the cast net, hence it can not be lost, it requires no special loading and it can be used while wading in shallow water, or in a boat.

In many areas of the world, cast nets have been thrown by grasping them at their apex with one hand and at the leadline with the other hand. Some anglers have even pulled the brail lines up through the center of the thimble also located at the apex to effectively shorten the size of the net. The net is the spun around the fisherman's body in an effort to create sufficient centrifugal force sufficient to open the net into the desired circular shape. This is very difficult to do with success because the axis of rotation about the user's hand is grouping all of the leadline at one central point. Since the axis of rotation is virtually equidistant in radius about the point of rotation, each of the lead weights tends to reach its moment of force simultaneously; the result is that all of the weight tend to stay clumped together rather than to spread, and the net fails to open fully if it opens at all.

In November of 2002, Paul C. Ardern, the applicant herein, was granted U.S. Pat. No. 6,474,012 for a cast net throwing device that simplified the process of throwing a cast net by utilizing a handle that attaches to the central portion of the mesh of the cast net and provides the user with mechanical advantages so useful that one could throw a cast net with one hand. First, the handle acts as a torque converter; with an arcuate flipping motion of the wrist, the fisherman creates greater leadline speed during rotation thus yielding greater centrifugal force. Therefore, the net opens faster and easier. Secondly, the use of a handle creates incremental radiuses between the axes of rotation and the distances to the leadline; these incremental distances cause the leadline to achieve their moment of force in sequence. The end result is that the leadline of the cast net achieves both a greater rotational speed with greater centrifugal force, and, due to the varying radii, each weight along the leadline reaches its moment of force independently and in perfect sequence thereby causing the net to easily open into the desired circular shape.

However, throwing cast nets with radii greater than the user's height remained difficult as the mesh of the cast net was being used to resist the leadline during a throw. In an effort to take advantage of the same mechanical advantage gained by mounting said handle about the center of the cast net, the improvement of the current invention, the subject of this invention, uses the brail lines of the cast net to resist the weight of the leadline as opposed to simply using the mesh of the cast net. By pulling the desired length of brail lines up through apertures that are integral with the handle, the very same dynamic rotation and planar motion may be achieved when throwing nets of larger sizes such as nets with a radius greater than the user's height.

In November of 2003, Phillip K. Prokaski was granted U.S. Pat. No. 6,643,972 for a device to assist in the throwing of a cast net. Prokaski's device does not claim the same mechanical advantage of Ardern's, however, upon close examination it may be seen that Prokaski's device is also a handle type device, such as can be seen in U.S. Pat. No. 6,474,012, used to effectively transfer energy to the leadline. Prokaski's device is different in that it does not grip the mesh of the net; as the baitfish are caught, and the user attempts to dump the fish out through bottom, the fish become stuck on the free-floating handle making fish removal very difficult. Another problem with Prokaski's design is that on smaller, more popular nets, the handle device of his claims cannot be used to transfer energy directly through the mesh of the cast net because his loose-fitting design allows the mesh to slip and slide along the perimeter of the handle. Another defect in Prokaski's design is that the user cannot directly grip the handle as it is always under the mesh of the cast net, this makes it difficult to hold when the net is wet and slimy. Prokaski's design uses the brail lines to resist the leadline instead of the mesh of the net allowing the user to shorten the distance between the user and the leadline during rotation by pulling the brail lines through long loose-fitting slots within the throwing handle. These long slots allow the brail lines to slide back and forth and do not maintain maximum separation between points of attachment to the cast net parts; therefore, the cast net will not open as easily as it could with more restrictive apertures. The separation between points of attachment are necessary to create sequentially varying radii from the axes of rotation so that a sequential engagement of force aids in the spreading/opening of the cast net. Unfortunately, the device utilizes a very large surface area that creates enormous friction against the water. This friction slows the net down during decent, and causes the net to close prematurely, both undesirable effects.

Prokaski's handle requires two-hands; one is used to gather the weights to the perimeter of said handle and then hold the brail lines in place, and or the other hand rotates the handle. The grips are released allowing centrifugal force to pull the lead line away from said throwing device. The design of the handle is difficult to grip as it is hidden under the mesh of the cast net and surrounded by a draped leadline. The slots do not encourage the leadline to remain separated during the rotation of the handle and therefore decrease potential for effective deployment.

As it will be made clear, the improved version of U.S. Pat. No. 6,474,012 (the father of the subject of this invention) utilizes the exact same advantages and benefits gained via said parent patent. By routing the brail lines through the handle's body so that they are free to move perpendicularly yet restricted to their assigned places about the ring, the angler is able to use the handle as a torque converter to increase leadline speed, and take advantage of the creation of variable radii about the leadline which cause the very important sequential engagement of force upon the leadline. Furthermore, by attaching the handle approximate the apex of the net the handle does not interfere with fish removal; rather, the apex is spread out enough to aid in fish removal by helping to hold the net apart. The design of this invention furthermore utilizes the least practical amount of resistance to the dropping of the net in the water. This throwing handle can be used to throw cast nets with one hand just like the parent U.S. Pat. No. 6,474,012, they may look nearly identical, and the improved cast net throwing device (handle) is effective to throw very large nets with one hand, by pulling a portion of the brail lines through the apertures within the handle. The advantage of one-handed throwing is important to any fisherman desiring to throw over thirty feet as is commonly needed in the Florida keys and other areas with very clear water. Using one-handed throwing techniques enables the angler to apply a full body motion, much like an athlete might pitch a baseball, thereby throwing much farther and more accurately than one could with a two-handed throw. Many angles also suffer problems that prevent them from using both arms, so one-handed throwing can be quite advantageous. Another benefit of one handed throwing relates to its simplicity; timing is less crucial with one-handed throws; recreational fishermen who rarely have opportunity to use their net benefit by having an easy-to-remember way to toss a perfectly cast net.

### BRIEF DESCRIPTION OF THE DRAWINGS

These and other features, aspects and advantages of the present invention will become better understood with regard to the following description, appended claims and accompanying drawings, wherein:

FIG. 1 is a plan view illustrating a prior cast net.

FIG. 1A is a plan view illustration the cast net with a throwing handle attached.

FIG. 2 is an enlarged plan view further illustrating portions of the prior art cast net shown in FIG. 1;

FIG. 2a-2d are perspective views showing one method for throwing a prior art cast net.

FIG. 2e is a perspective sequential view showing one method of the cast net with a throwing device being gripped and thrown.

FIG. 2f is a perspective view of the handgrip and lead line placement demonstrated in FIG. 2e.

FIG. 3 is an exploded, assembly perspective view illustrating a first embodiment of the cast net throwing device according to the present invention, and a portion of the cast net shown in FIGS. 1 and 2;

FIG. 4 is a perspective view of a the cast net throwing device and net shown in FIG. 3 but with the cast net throwing device secured to the net;

FIG. 5 is a cross sectional view taken along line 5-5 in FIG.4;

FIG. 6 is a plan view of a portion of a cast net throwing device shown in FIG. 3 and 4;

FIG. 7 is a cross sectional view taken along line 7-7 in FIG. 6;

FIG. 8 is an exploded assembly, perspective view illustrating a second embodiment of a cast net throwing device according to the present invention, with a portion of the cast net shown in FIGS. 1 and 2;

FIG. 9 is a perspective view illustrating a cast net throwing device and cast net shown in FIG. 8, but with the cast net throwing device secured to the net,

FIG. 10 is a cross sectional view taken along line 10-10 in FIG. 9;

FIG. 11 is a plan view illustrating one of the rings of a cast net throwing device shown in FIGS. 8-10;

FIG. 12 is a cross sectional view taken along line 12-12 in FIG. 11;

FIG. 13 is a plan view of a second ring of a cast net throwing device illustrated in FIGS. 8-10;

FIG. 14 is a side elevation view of the ring shown in FIG. 13;

FIG. 15 is a cross sectional view taken along line 15-15 in FIG. 13;

FIG. 16 is an exploded assembly, perspective view illustrating a cast net throwing device according to a third embodiment of the present invention, and a portion of the cast net shown in FIGS. 1 and 2;

FIG. 17 is a perspective view illustrating a cast net throwing device and cast net shown in FIG. 16, but with the cast net throwing device secured to the net;

FIG. 18 is a cross sectional view taken along line 18-18 in FIG. 17;

FIG. 19 is an exploded assembly, perspective view of a cast net throwing device according to a fourth embodiment of the present invention, and a portion of the cast net shown in FIG. 1 and 2;

FIG. 20 is a perspective view illustrating a cast net throwing device and cast net shown in FIG. 19, but with the cast net throwing device secured to the net;

FIG. 21 is a cross sectional view taken along line 21-21 in FIG. 20;

FIG. 22 is a top plan view illustrating a cast net throwing device shown in FIGS. 19 and 20;

FIG. 23 is a bottom plan view illustrating one of the elongate members of a cast net throwing device shown in FIGS. 19, 20 and 22;

FIG. 24 is a cross sectional view taken along line 24-24 in FIG. 22;

FIG. 25 is a perspective view illustrating one embodiment of a cast net throwing device according to the present invention secured to the cast net shown in FIGS. 1 and 2, illustrating the cast net in flight.

FIG. 26 is a perspective view showing a cast net throwing device that incorporates an integral thimble secured by a plurality of support arms.

FIG. 26a is a plan view of a throwing device for a cast net with an integral thimble secured by an integral grate.

FIG. 27 is a perspective view of a segmented throwing device attached to a cast net.

FIG. 28 is a plan view of a segmented handle of FIG. 27 that may be assembled after purchase.

FIG. 28a is a cross sectional view taken along line 28-28 in FIG. 28.

FIG. 28b is a plan view of connecting arm 196 for disassembled collapsible throwing device illustrated in FIGS. 27 to 28c.

FIG. 28c is a perspective view showing how the segments of a segmented throwing device may be secured together.

FIG. 29 is a perspective view of a disassembled throwing device with integral brail line guides.

FIG. 29a illustrates a cast net throwing device installed on a cast net with brail lines passing through integral brail line guides.

FIG. 29b is a cast net throwing device with apertures through which the brail lines pass and with a mesh or grid center.

FIG. 29c is a cross sectional view of FIG. 29b taken along line 29-29.

FIG. 29d is a perspective view of a cast net throwing device formed with apertures throughwhich the brail lines pass and attached to a cast net.

FIG. 29e is a cross sectional view of FIG. 29d taken along line 29e-29e.

FIG. 30 is a perspective view illustrating a new method of throwing a cast net with the brail lines being pulled up through the apertures 214 in FIG. 29a.

FIG. 30a illustrates the final preparations prior to rotation and release for the new method of throwing a cast net which utilizes a mechanical advantage via a cast net throwing device.

FIG. 31 and 32 are perspective views showing the rotation and release of the cast net of FIG. 29a.

FIGS. 33-39 are perspective views illustrating a variety of handle designs useful to impart a mechanical advantage to a cast net and how to determine their particular maximum added radius upon the user's points of rotation.

FIG. 39 is a perspective view of a flexible cast net throwing device designed for compact storage.

FIG. 40 is a perspective view of flexible cast net throwing device attached to a cast net, compactly packaged for retail sale.

### BRIEF DESCRIPTION OF THE INVENTION

As is evident from the above description unless one has a particular degree of expertise, cast nets can be difficult to throw. This invention relates to a handle that is integral with the cast net wherein the handle makes it easier to throw the cast net in such a manner that a planer and circular motion is imparted to the cast net. As a result of this planar and circular motion, the weighted outer periphery of the net pulls the net into a circular configuration, to cause the net to open. This opening of the net is the result of centrifugal forces which are transferred from the users bodily rotations, then magnified by the use of the attached handle, through either the limp brail lines of the net or the mesh of the net, to the weighted outer periphery of the net, the leadline. In the field of mechanics, this is known as a dynamic force; in other words, due to the torque conversion qualities of the attached handle, the user is able to apply a secondary rotational force upon a cast net while is already in a motion of rotation.

A great way to envision the dynamic motions involved would be to picture a Ferris-wheel that you might see at a fair. From a distance, you can easily observe a gentle vertical rotation much like the horizontal rotation of the users main axis of rotation when throwing a cast net. Now envision an ancient war tool, the catapult. By attaching a catapult to the outer periphery of the Ferris-wheel, and engaging the catapult in the direction of rotation, while being in a rotational motion, one may observe a dynamic motion that is nearly identical to the motion achieved by a fisherman utilizing the handle to throw the net; the arm of the catapult is much like the handle of the cast net in that they both accentuate motion thereby providing a mechanical advantage. Without the attached handle, centrifugal forces are difficult to generate, especially about the axis of the user's wrist (the secondary, dynamic axis of rotation) which only rotates about one-half of an inch in a 15-degree arc. The energy fails to translate to the perimeter the cast net (the leadline) due to nearly no flexural strength (bending of the limp portions of the cast net when pressure is applied); however, the very same 15-degree arc is magnified with the use of the handle. The handle magnifies the rotation by about three-and-a-half-times when using a handle with a ten-inch distance between its two most opposite points of attachment. This magnification of energy is the translated to the leadline in sufficient quantity to cause moments of force (the exact point wherein energy is changed from translational to rotational) to occur upon individual leads attached to the leadline so that when the handle is released the leads shoot away from their axes of rotation and the net is dramatically pulled into an open circle.

The main improvement of current subject of the described invention is the integration of apertures within said handle. The thimble of the cast net, which previously accepted the brail lines and protected the mesh of the net, becomes an unnecessary part of the cast net. By running the brail lines directly through a multiplicity of apertures within the handle, the same dynamic rotation may be achieved. Furthermore, the length of the distance from the axes of rotation to the leadline may be shortened by pulling a portion of the brail lines up through the handle thereby using the brail lines of the cast net to resist the leadline as opposed to the mesh of the leadline when desired; this enables larger nets to be thrown with ease. One-handed, long distance throws of larger nets may be achieved; these types of throws are particularly desirable to fisherman fishing from shore, or targeting certain species of baitfish such as ballyhoo wherein the distance between the fisherman and the school of baitfish is often greater than thirty feet.

Another mechanical advantage of the handle causes the net to easily spread into a full circle due to sequential engagement of force about the periphery of the cast net at the leadline. The handle improves timing by creating incremental differences in the radius about the axes of rotation. Since the furthermost point of attachment of the leadline to the handle is of a greater radius about the axes than the shortest point of attachment to the handle about the axes, the very same rotational speed has an incrementally varying effect upon the individual leads attached to the leadline. The portion of the leadline being restrained by the handle at the point of the greatest radius about the axes will move faster than the lead following just behind it until they both reach their independent moments of force and change their motion from a motion of translation (dragging in a straight line behind the force) to a motion of rotation (centrifugal force). If all the weights were being spun from exactly the same point of rotation, as is often done via historic methods of throwing, there is no significant separation of the moments of force, therefore, no natural desire for the net to spread open into a circle. And since the handle is permanently attached to the mesh of the net, and is on top of the mesh, the handle may be gripped with one hand and thrown one-handed; no other design ever created can do this with a very large net.

In the prior art, cast nets have been thrown primarily by the user gripping the mesh and swinging the leadline outer periphery of the net, often laying mesh over portions of their body, while simultaneously placing a lead from the lead line in their mouth.

The design of U.S. Pat. No. 6,474,012 by Ardern was the first to allow one handed throwing via an attached throwing handle. Another attempt to throw the net using a throwing handle was patented by Prokaski in U.S. Pat. No. 6,643,972; while his design does permit the user to reduce the size of the net for throwing, the handle may not be easily gripped and thrown with one hand. The Prokaski design does not attach to the mesh of the net. The design is flawed in that during bait removal, the handle falls impotently to the bottom leadline effectively closing the opening wherinwhich the bait should normally fall out. Another design flaw is that the handle is unable to be gripped directly as it floats loosely under the mesh of the net. Furthermore, Prokaski recommends the user pull the leads as close to the handle as possible; doing such actually reduces both centrifugal force and leadline speed; high leadline speed is desirable especially when throw from high bridges as once the nets rotation slows down the cast net begins to close, prior to impact with the water. Another problem with Prokaski's handle is the resistance to sink rapidly once contact with the water is made; each of his designs maintain a substantially disc-like configuration that restrict normal sink rates. The area encompassed is unduly reduced so the catch is reduced. It is commonly agreed in the industry that a fast sink rate is necessary to be successful in catching baitfish prior to their escape.

The handle of this invention and its forefather U.S. Pat. No. 6,474,012 allows fishermen to throw with one hand, faster, farther, and more accurately than with any other method; the user grips the handle of the cast net with his throwing hand. When throwing one handed the preferred method of throwing is similar to the throw of a discus in that the fingers grip the handle palm down with knuckles on top of the handle. If the thrower wishes to reduce the distance that the net pulls away from the handle during rotation, a portion of the brail lines may be drawn up through the apertures within the handle and gripped in the throwing hand. Then a small portion of the lead line, radially outward from the gripping position, is stuffed in between the user's palm and the handle. An arcuate motion in the direction of the thumb is initiated with the body; the user rotates approximately 180 degrees (just enough to change the motion of the leadline from a motion of translation to a motion of rotation). Then as the bodily rotation continues, a secondary dynamic force is applied about the axis of the wrist. As the wrist flips the handle, a super-powerful surge of energy is sent to the leadline in an orderly sequence that causes the leadline to fan into a wide-open circle upon release. The total rotation movement required to achieve sufficient centrifugal force is approximately 230 degrees to 270 degrees. The user may use all the parts of his body to add up to this amount; for example, twisting the lower torso 90 degrees, the upper torso 60 degrees, the arms 30 degrees and the wrist 90 degrees. To achieve rotation in less that about 230 degrees is difficult under any circumstance because of the laws of motion, and the design of a cast net, as centrifugal for begins to occur after 180 degrees. Because the lead line with its weights is located on the periphery of the cast net, the weights traveling in a generally circular pattern pull the flexible circular net into its full circular configuration. This is the recommend method for casting the net one-handed; with use even recreational users soon catch on to the fact that all they have to do is initiate rotation at the ring providing smooth acceleration and simply release the net between 230 and 270 degrees; centrifugal force does the rest.

The cast net of this invention addresses all of the aforementioned issues; the handle is easy to grip with one hand as it is mounted on the top of the nets mesh and has an inner radius designed to be gripped with the fingertips of one hand. The handle stays in place at the top of the net so that fish removal is easier than it would be without a throwing device attached, and much easier than Prokaski's design that actually closes off the bottom area. Another benefit of the design is that it adds almost nine square feet to the surface area of the cast net on a net with a seven-foot radius because the apex of the net is released from its normal position being constricted by a small thimble. The design of this handle resists less water as it drops; the net stays open longer and sinks faster.

The handle for use in this invention can assume any convenient shape; however, bar and ring shaped throwing devices are preferred. This throwing handle portion allows the thrower of the cast net to apply a mechanical advantage to the throwing process.

In summary, this invention relates to a cast net having a centrally located throwing device, which can be gripped by a user, such that a user is able to apply a mechanical advantage to the cast net throwing process in such a manner that the opening of the net is enhanced.

In addition to these advantages, a user can likewise throw the cast net a greater distance with greater accuracy.

### Description of the Preferred Embodiment

From the above discussion it can be seen that this invention relates to a cast net having a throwing device whereby a user can readily grip and impart a mechanical advantage to the throwing process. As a result of the fact that the cast net can be readily gripped, it can be easily thrown in such a manner that the net portion, of the cast net, assumes a circular configuration when it is airborne. That is to say the cast net of this invention can be easily thrown in such a manner that it opens. The opening of a cast net is extremely important as the surface area of a cast net is relatively small. A cast net functions by making contact with the surface of a body of water usually a shallow estuary. The outer periphery of the cast net comprises a weighted lead line. In order to open when the cast net is airborne, the lead line must be spinning in a circular fashion. When the cast net leaves its airborne travel phase by coming into contact with the water surface, the circular motion of the lead line weights ends. The lead line weights then start a downward vertical motion which terminates when the weights come into contact with the estuary bottom. The vertical fall of the lead line weights causes the net to descend in the water in an umbrella like configuration. Because the weights of the lead line are generally disposed in a circular pattern, any baitfish which are within the circular pattern are trapped. The net is then drawn in by brail lines 26, the function of which will be described in greater detail herein below. The further drawing in the brail lines reduces the volume of the confined area thereby aiding in the entrapment of the baitfish.

To describe the function of a cast net in the simplest of terms, a cast net is thrown in such a manner that it strikes the water surface in a circular pattern. As a result of weights, which are integral with the outer surface of the net, the cast net sinks, entrapping any baitfish that may be under the net. As is discussed above the term baitfish as used in connection with this invention means baitfish, shrimp, eels, etc.

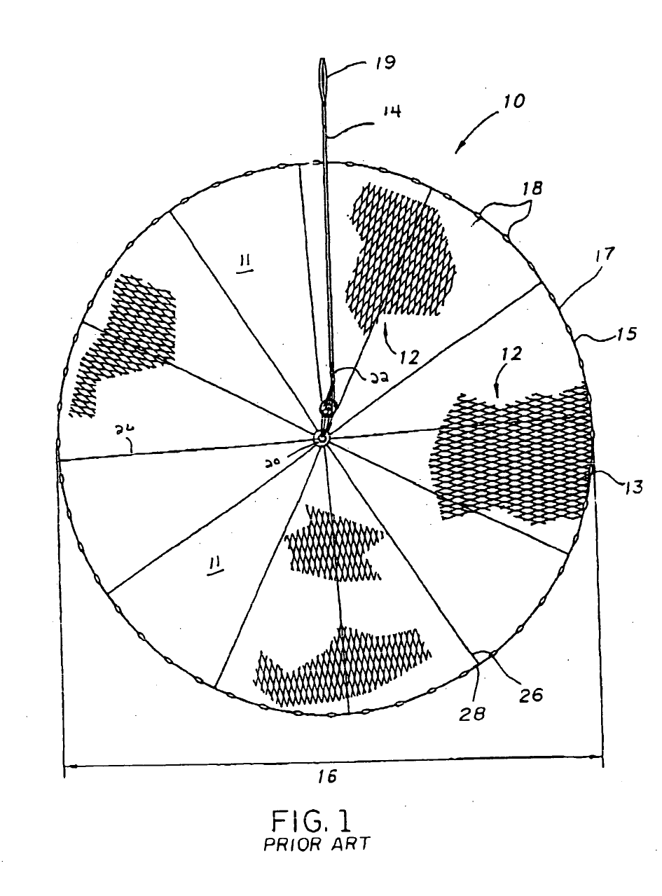

Knowledge of the parts and functions of a cast net will provide a better understanding of the subject invention. Referring to FIG. 1 it can be seen that cast net 10 has a circular shape. The net portion 13 may be formed from a plurality of pie shaped segments 11 which are sewn together. A thimble 20 is attached to the net portion 13 at the apex of the net where pie shaped segments 11 converge. The outer circumference of cast net 10 is defined by a lead line 15 which is sewn to the outer periphery of net portion 13, a plurality of lead weights 18 are strung on lead line 15.

A throw line 14 is further provided for. One terminal end of throw line 14 incorporates a loop 19 which is secured to a thrower's wrist. The other terminal end of throw line 14 is attached via a swivel 22 to a plurality of brail lines 26, the other end of brail lines 26 being attached to lead line 15. The mesh of net portion 13 can vary depending upon the size of the baitfish which is targeted. Net portion 13 can be formed from natural or synthetic fibers or monofilament polymeric materials.

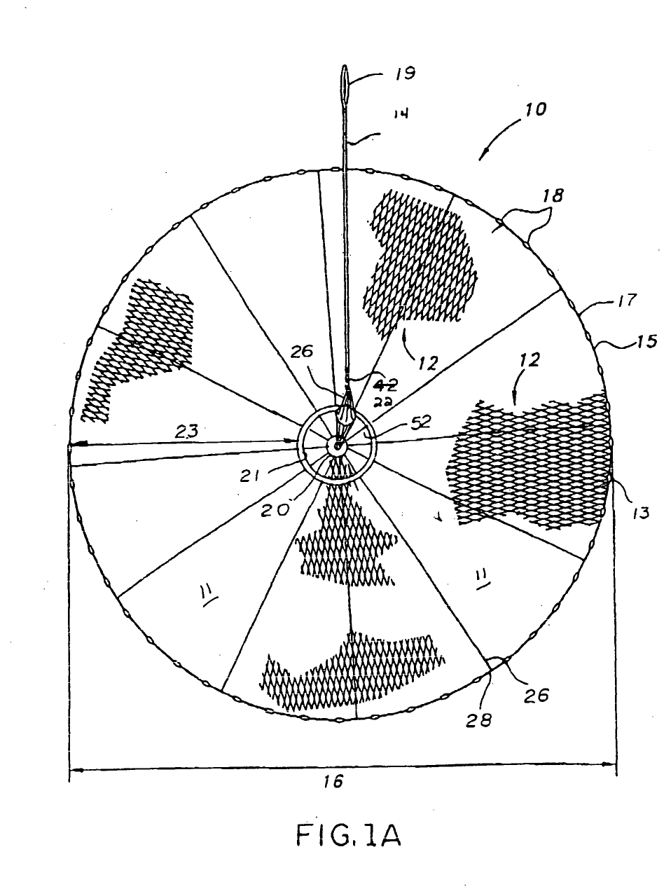

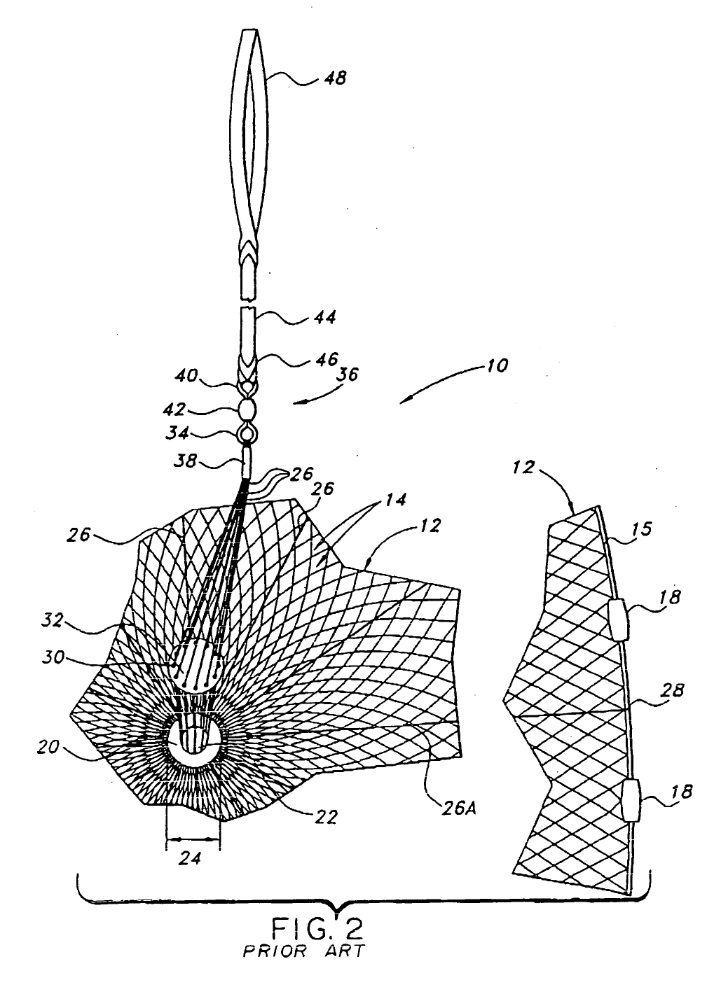

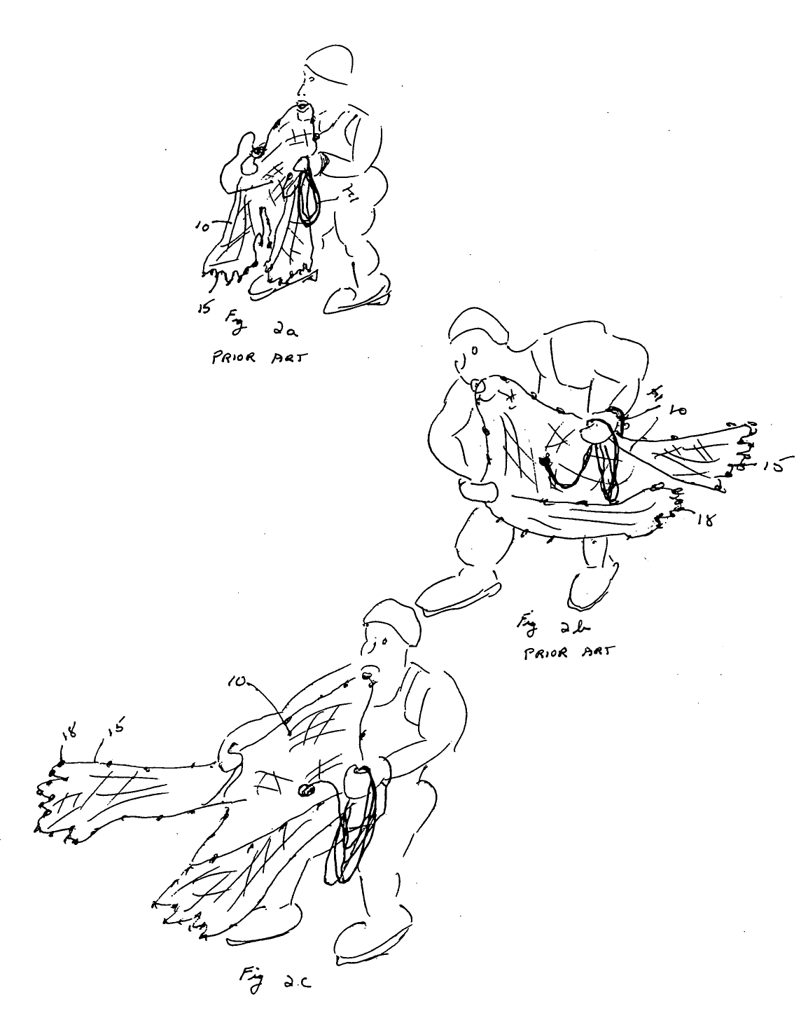

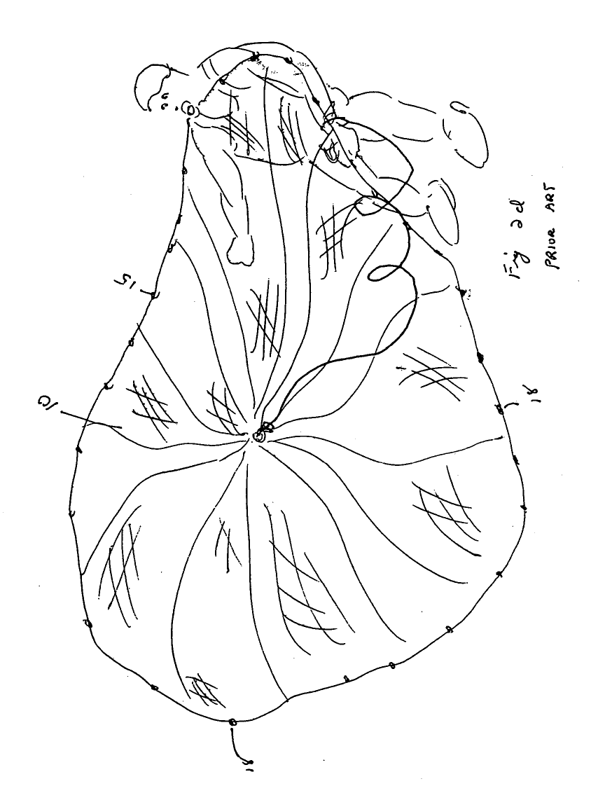

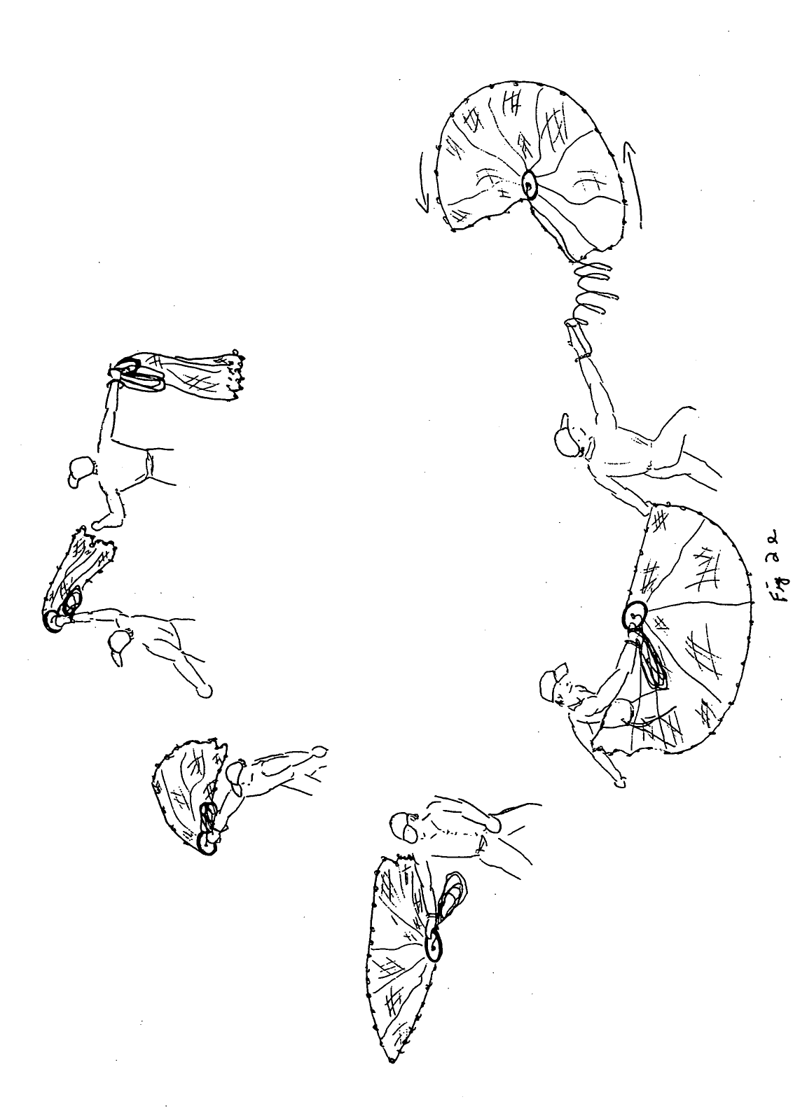

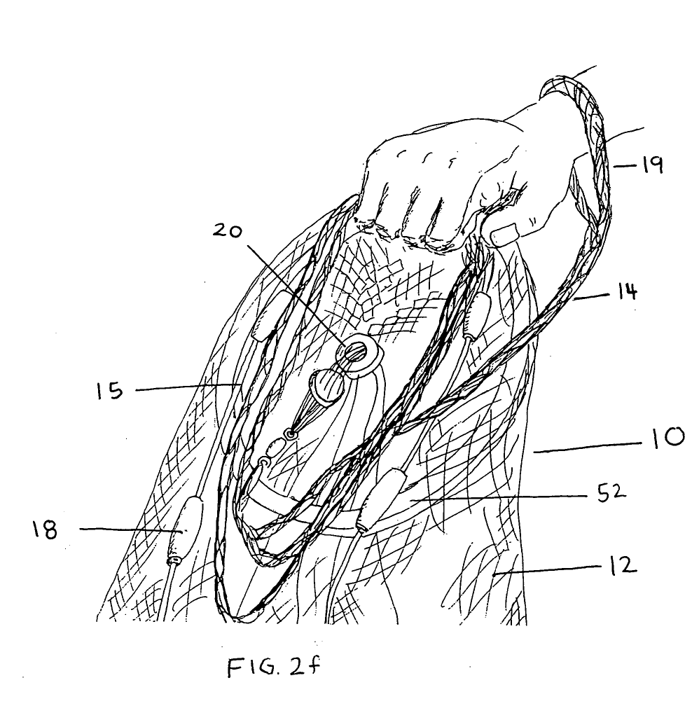

As a result of the subject invention, the process of throwing a cast net has been greatly simplified. In order to exemplify this fact, the method whereby the prior art cast net is thrown is illustrated in FIGS. 2a, 2b, 2c and 2d and a method for throwing and gripping the cast net of this invention is illustrated in FIGS. 2e and 2f.

Referring to FIGS. 2a-2d which are representative of the prior art, it can be seen that two hands and mouth placement of the lead line may be necessary to throw cast net 10. For a right-handed person, throw line 14 is secured to the left wrist of the user. The balance of throw line 14 is then loosely coiled in the left hand of the user. A further portion of lead line 15 is then gripped between the teeth of the user. An additional portion of net mesh, about ⅔ from the apex is then gripped in the right hand of the user. The balance of the net is then gripped by the thrower in his left hand. With this complicated placement of cast net 10, it is now ready for the final act of throwing as is shown in FIG. 2b and 2c. In throwing, the thrower coils his body in counter clockwise fashion and then uncoils his body in a clockwise fashion while at the same time releasing the net portions which were gripped in his hands. With the release of the portion of net which was gripped by the hands, cast net 10 is propelled forward in a plane which is parallel with the surface of the water. Lead line 15 is released out of the thrower's mouth precisely before the momentum of the leads 18 would otherwise snap against the grip of the user's teeth. Because the users body is uncoiled in a clockwise fashion a clockwise and planar motion is imparted to lead line 15 and in particular to weights 18. This clockwise motion then causes net 10 to open. Regretfully, net 10 often does not open as improper or insufficient circular motion is imparted to lead line 15 and its weights 18. This failure results from the fact if there are any glitches in carrying out the throwing procedure, the delicate process of causing cast net 10 to open is disrupted.

Even minor variations in the throwing process will result in the unsatisfactory opening of cast net 10. For example, if the user releases the lead line 15, contained in his mouth, too early, the flow of lead line 15 will be disrupted; and the whole throwing process will fail because cast net 10 does not open.

The above described prior art process is likewise objectionable from a health point of view due to the placement of the lead line in the mouth of the user, thereby exposing the user to oral heavy metal contamination, and potentially breaking off teeth. Further, while the oral placement of the weights is acceptable in a clean water environment, the process is highly objectionable in contaminated waters, as the user will be exposed to oral bacterial contamination. The above described process for throwing the prior art cast net is also disadvantageous as the mass of weights 18, 15 are carried on the frame of the user. This carrying of the total weight of cast net 10 on the users frame is very tiring, particularly when the user is waiting for the opportune time to throw cast net 10. For example while the user waits for the prey baitfish to school up. While the act of throwing a cast net does not appear to be strenuous, in fact a series of throws in accordance with the above described prior art sequence can be very tiring and strenuous. The above described prior art procedure is also disadvantageous in that it cannot be quickly carried out. Instead the process is slow due to the complicated process whereby the cast net is loaded onto the user's body. That is, in the prior art, a user cannot quickly throw a cast net. The throwing of a cast net in accordance with this invention is at least three times faster than the prior art method described above.

Recently, U.S. Pat. No. 6,474,012 the father of the subject of this invention, provided the simplest method ever seen for throwing a cast net. Not only is the angler freed from placing a portion of the dirty leadline in his mouth, or draping any portion of the net over a part or parts of his body, but the fisherman could now throw longer more accurate casts using one hand.

To throw the improved cast net of this invention, the fisherman simply grasps the throwing device palm down, reaches below the throwing hand and grasps the portion of the leadline radially outward (i.e. hanging below his gripping position) from his throwing hand's grip on the handle, stuffs that portion (about 6 to 15 inches) of the leadline between his palm and the throwing handle, then accelerates rotation, the net is released between about 230 degrees to about 270 degrees of rotation. Due to centrifugal forces the net opens fully every time.

In contrast to the above described problem with the prior art cast nets and throwing process, the cast net of the subject invention, which incorporates a throwing handle, can be quickly thrown; the throwing process is not strenuous and the user is not exposed to oral heavy metal or bacterial contamination.

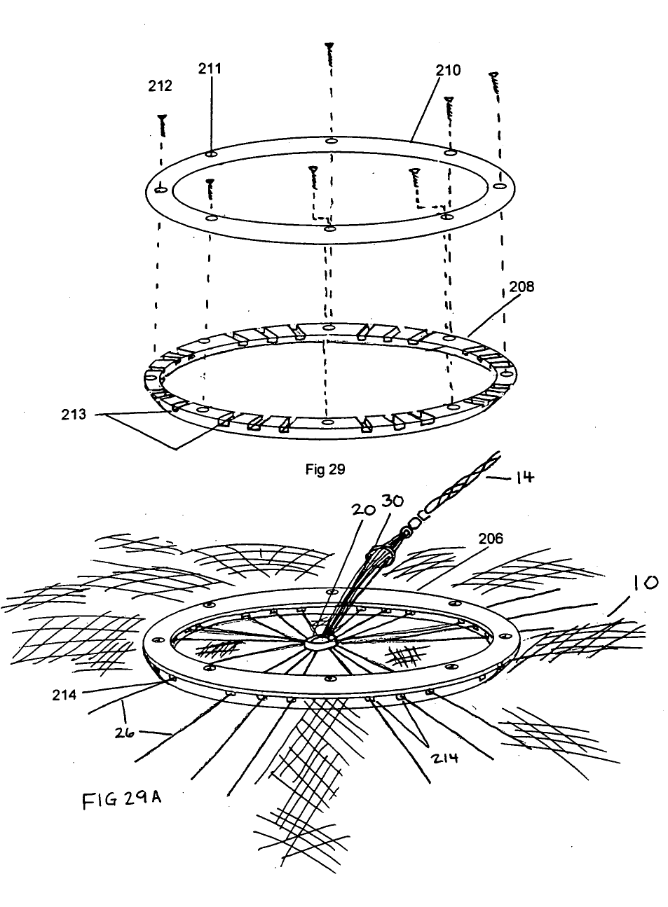

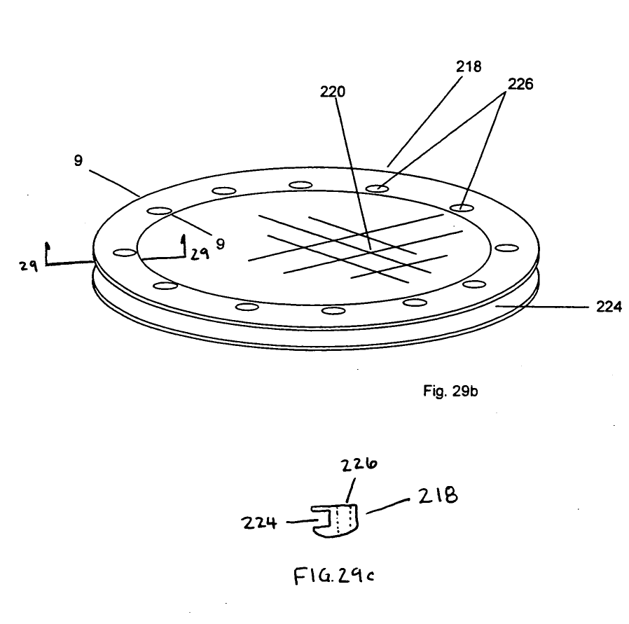

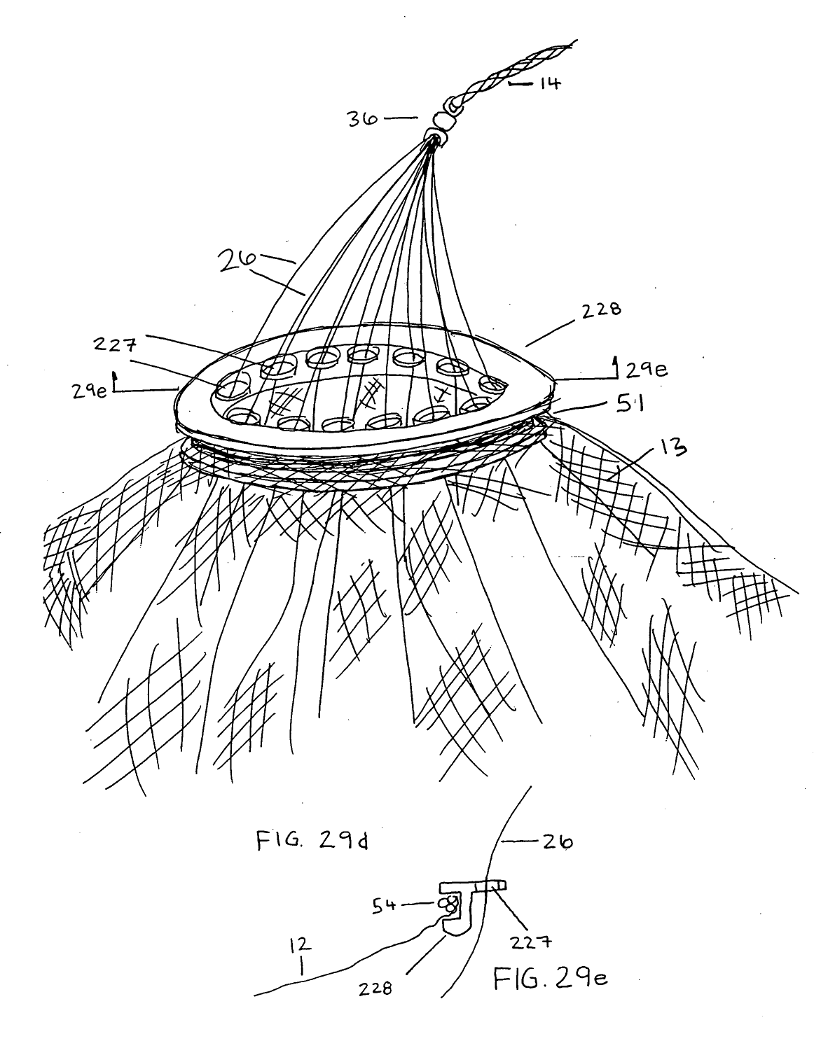

The current invention provides for a new throwing process, which incorporates a throwing handle, and is fundamentally different than the prior art throwing process as is described above in that a mechanical advantage is imparted to the throwing process. By use of the throwing handle of this invention, as is illustrated in FIG. 29d, a cast net throw may be executed with one hand.

In one of the throwing processes which may be used with the cast net of this invention, throw line 14 is secured to the right wrist of a right-handed person. The balance of the throw line is then coiled in the right hand of the user, with an overhand grip, the user then grips the throwing handle which is illustrated in FIG. 2e and 2f, as a throwing ring 228. Throwing ring 228 is a preferred embodiment for a throwing handle for use in this invention. The portion of lead line 15 which is radially outward from the gripped portion of throwing ring 228 is then placed between the angler's palm and the throwing ring 228, over the gripped portion of throw ring 228, inside out. Cast net 10 is then ready to throw. If the fisherman desires to shorten the distance that the leadline 15 is able to swing away from the throwing ring 228, he may pull a desired portion of the brail lines 26 through the apertures 227 of ring 228 and hold the in the palm of his throwing hand. In throwing, the user coils his body in a clockwise fashion with his right hand behind him and then uncoils his body in a clockwise fashion, releasing throw ring 228 with an arcuate planar motion while allowing the coiled throw line 44 to play off of his right hand. Because of the mechanical advantage imparted to the muscular action of the user in the throwing process the, velocity of weights 18 at the release point is substantial greater than that of the prior art process. This increase in velocity generates additional centrifugal force as weights 18 spin about throw ring 228 causing net portion 13 to be quickly pulled into a desirable circular pattern.

From the above description it can be seen that the cast net of this invention is basically different than the cast nets of the prior art. In the cast net of this invention, a throwing device, which is integral with the cast, is provided for. This throwing device, when used, provides a mechanical advantage for the throwing process. Further, this throwing device allows for one handed throwing, as is to be compared with the prior art, wherein the throwing process may entail the use of two hands and a person's mouth.

The heart of the subject invention is the fact that the cast net of the subject invention incorporates an integral throwing device whereby the force imparted to the weights of the lead line may be magnified by a mechanical advantage. This force magnification is to be contrasted with the prior art process of throwing a cast net, as is illustrated in FIGS. 2a and 2b wherein there is no force magnification. That is, the force imparted to weights 18 of lead line 15 in FIGS. 2a and 2b is essentially 1 to 1. In contrast using the cast net of this invention, the throwing force of the user multiplied as a result of the sling effect as is illustrated in FIG. 2e as is shown in FIG. 1A. By gripping the throwing device 228 at point 21 as is shown in 2f, the user adds a length of radius to the arc of two separate points of rotation. As shown in FIG. 2e, the major point of rotation is about the user's frame; this added radius formed by extending his natural reach results in increased lead line 15 velocity. A dynamic force occurs prior to release as the user engages a secondary force of rotation by flipping his wrist in a discus-like throwing motion. It is easy to see that the added radius of the throwing device 228 substantially increases the effect rotation about the secondary axis at the user's wrist resulting in dramatic leadline 15 acceleration. The advent of this mechanical advantage results from the fact that in accordance with this invention, a throwing device is provided such that the net can be gripped for throwing at a point other than the lead line or limp mesh.

From the above discussion, it is obvious that weights 18 of lead line 15 are a critical part of this invention. Weights 18 are essentially the medium whereby the muscular energy of the user is transferred to cast net 10 in such a manner that net portion 13 is pulled into a substantially circular pattern. Further weights 18 cause cast net 10 to sink once lead line 15 has come into contact with the surface of the body of water on to which cast net 10 is thrown. As is known in the prior art, the sinking rate of cast net 10 can be made to vary depending on the number of and the mass of the weights used per radius foot of the cast net. In fact cast nets are categorized by the pounds of weight used per radius foot of the net.

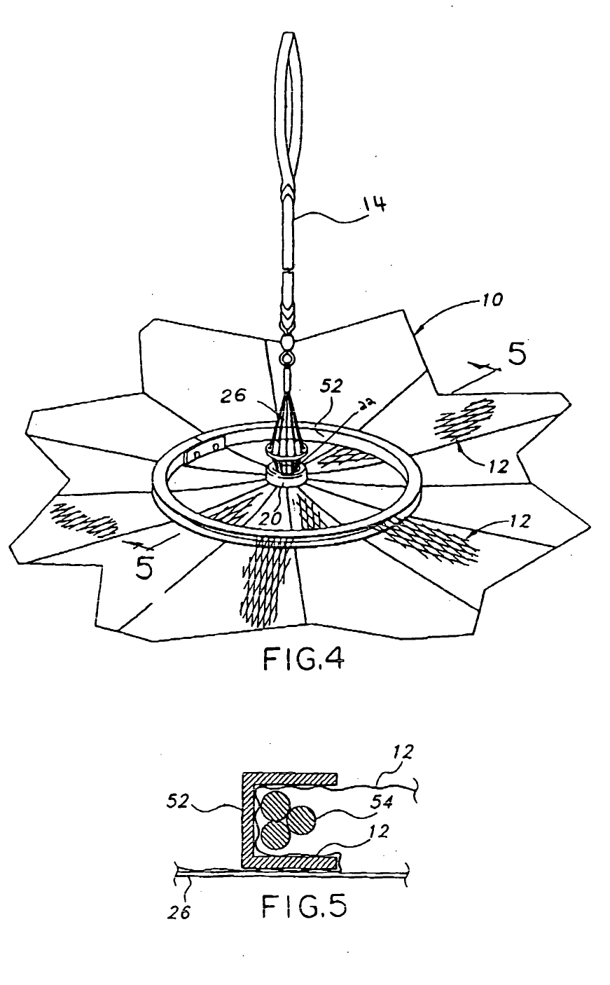

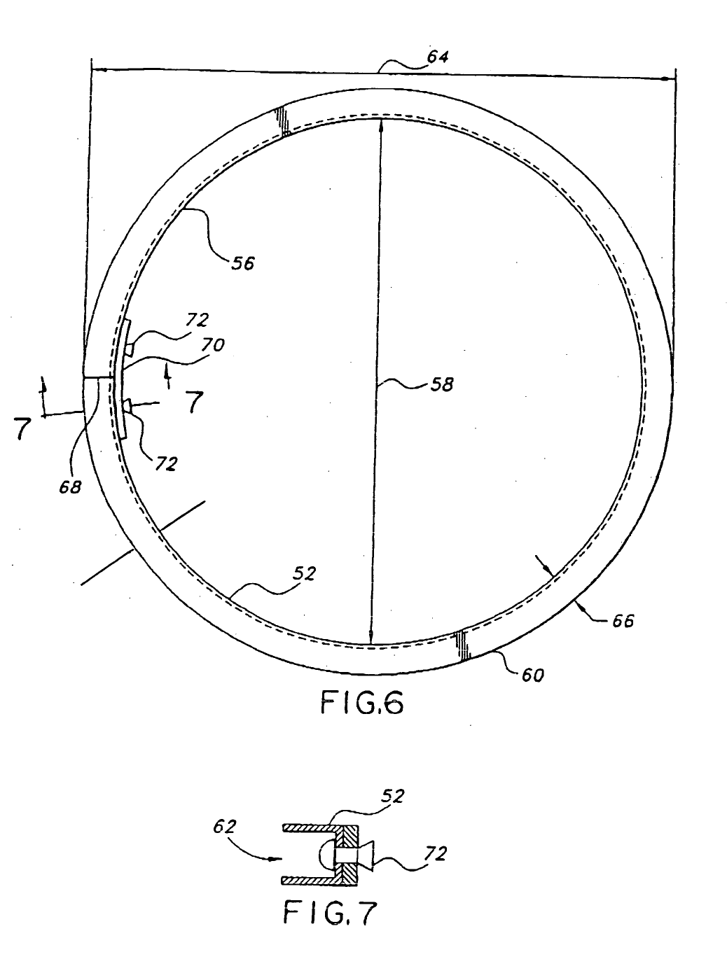

Referring further to FIGS. 4 and 6, additional details of cast net 10 can be seen; these additional details are generally known in the prior art. These details will be described herein below.

The cast net 10 further includes an annular member 20, referred to in the art as a thimble, which is substantially centrally disposed relative to the netting 12 and is secured to net portion 13. In the usage of throwing device 228, of FIG. 29d, the annular member (a thimble) may be deleted as part of cast net 16 and be replaced via apertures 227 within throwing ring 228. The sole purpose of the thimble was to protect the mesh of the net against abrasions caused by brail line 26 movement during use. The inner surface of thimble 20 defines an aperture 22 extending through the thimble 20. The diameter of thimble 20 is typically about 1½ inches to 2 inches. Thimble 20 is typically made of plastic. When the cast net 10 is fully opened and is resting upon a flat surface, the central portion of the netting 12 may be slightly raised or gathered, which is typically referred to in the art as the horn of the cast net 10. The thimble 20 is attached to the netting 12 in the area of the centrally disposed horn. The particular construction of thimbles is well known in the art, as well as the manner in which netting 12 is secured to the thimble 20. For instance, netting 12 may be wrapped, tied and bonded to the thimble 20 which may comprise a two piece construction to facilitate the attachment of netting 12 to thimble 20, as known in the art.

As is illustrated in FIG. 1, 1a and 2, cast net 10 also includes a plurality of brail lines 26 which are effective for facilitating the closing of cast net 10 as subsequently discussed. Each brail line 26 is secured at a first end to the lead line 15. For instance, one end of the brail line 26A shown in FIG. 2 is secured to lead line 15 at location 28. Typically, the brail lines 26 are tied to the lead line 15, with the use of appropriate knots (not shown). Each brail line 26 then extends, in a substantially radial direction beneath the netting 12 to the center of cast net 10, with the brail lines 26 then extending upward through the aperture 22 defined by thimble 20, as shown in FIG. 2. Each brail line 26 then passes through an aperture 30 formed in a disc member 32, typically referred to in the art as a spacer, which is effective for preventing the brail lines 26 from becoming tangled with one another thereby facilitating the smooth operation of cast net 10. The spacer 32 may be constructed of a plastic or composite material. Each brail line 26 then passes upward through a first eyelet 34 and extends downward, passing through an opposite one of the holes 30 formed in spacer 32, downward through the aperture 22 formed in thimble 20 and radically outwardly beneath netting 12 where it is secured to the lead line 15 at a second, substantially opposite location in the manner discussed previously. Accordingly, each of the brail lines 26 includes first and second ends secured to the lead line 15 at substantially, diametrically opposed locations, with the approximate middle of each brail line 26 passing through eyelet 34 of swivel member 36. For instance, brail line 26A is secured at one end to lead line 15 at location 28, with the opposite end of the brail line 26A being secured to lead line 15 at a position which is substantially diametrically opposite location 28. As is shown in FIG. 2, the cast net further includes a clasp 38, positioned below eyelet 34 of swivel member 36, which secures the brail lines 26 together at this location.

Swivel member 36 further includes a second eyelet 40, with both of the eyelets 34 and 40 being secured to a barrel member 42 of swivel device 36. The particular construction of swivel device 36, including the manner in which eyelets 34 and 40 are attached to barrel member 42, is well known in the art. The cast net 10 further includes a throw line 14, which is secured at a first end 46 to the eyelet 40 of swivel member 36. The opposite end of throw line 14 defines a loop 19 which may be passed over the wrist of the thrower of the cast net 10. Brail lines 26 are interconnected with throw line 14 via swivel member 36. After cast net 10 has been cast and sunk below the surface of the water, the fisherman may close the net 10 by pulling on throw line 14, thereby capturing baitfish, shrimp, etc. within net 10. The throw line 14 operates in combination with brail lines 26 to close the cast net 10.

As can be seen from FIG. 1A the throwing handle of this invention, herein illustrated as ring member 52, is generally located approximate the center of cast net 10. The placement of the throwing handle is in the central portion of the cast net. The distance between the point at which the throwing device is gripped and the point most distant where the net portion is attached to the throwing device determine the mechanical advantage of the throwing device. For cast nets in the three foot to twelve foot range, rings having a diameter of from about one inch per radius foot up to 33% of the diameter of the cast net have been found to be useful. For purposes of this invention these sizes are referred to as the mechanical advantage of the throwing device. Preferred ring sizes have diameters of from about 10 to about 16 inches. These preferred ring sizes function well and they are easy to store on a boat. While this description relates to circular rings, it is understood by one skilled in the art, that the same analogies can be applied to non-circular throwing devices.

The handle member which is used to impart a mechanical advantage in the throwing of the cast net of this invention can assume any convenient embodiment. A preferred embodiment for the handle member of this invention is shown in FIG. 29d wherein ring member 228 comprises a throwing handle. Ring type throwing handles are a preferred embodiment for use in this invention as they evenly distribute centrifugal force to the net, are inexpensive, easy to manufacture, easy to grip and can be readily secured to the net portion 13 of the cast net.

In this preferred embodiment, the diameter ring member 228 should bear a relationship to the diameter of cast net 10. It has been found that the diameter of ring member 52 should be from at least about one inch per radius foot of the cast net up to about 66% the radius of cast net 10, a more preferred range is from about 8 inches to about 24 inches with a most preferred diameter for ring meter 228 being from about 10 inches to about 16 inches.

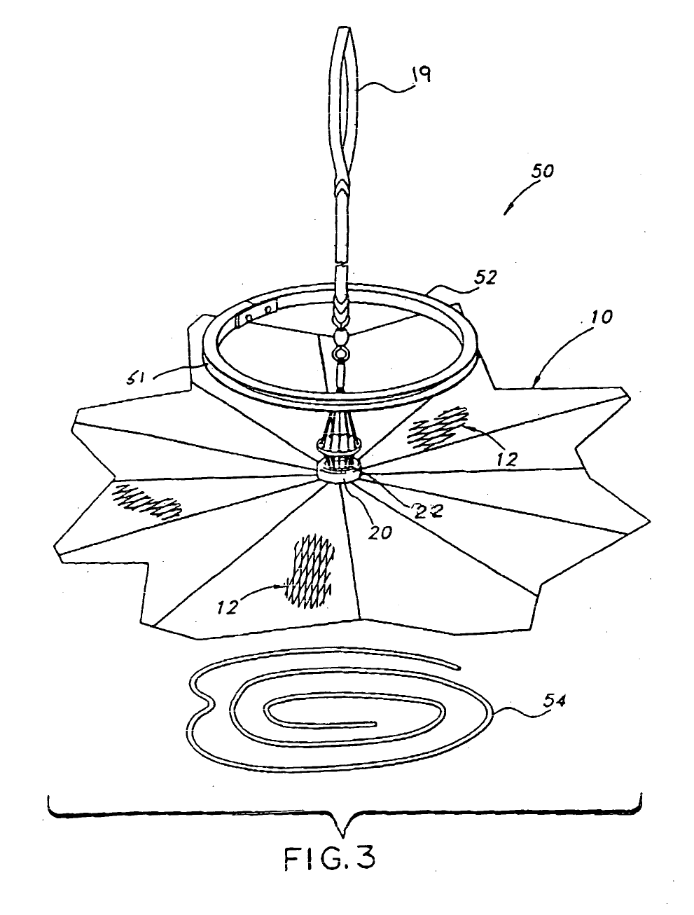

As is shown in FIG. 3, ring member 52 may be formed in such a manner that its outer periphery comprises an annular groove 51.

Net portion 13 is secured to ring member 52 by drawing net portion 13 into annular groove 51′ with a suitable twine type binding material.

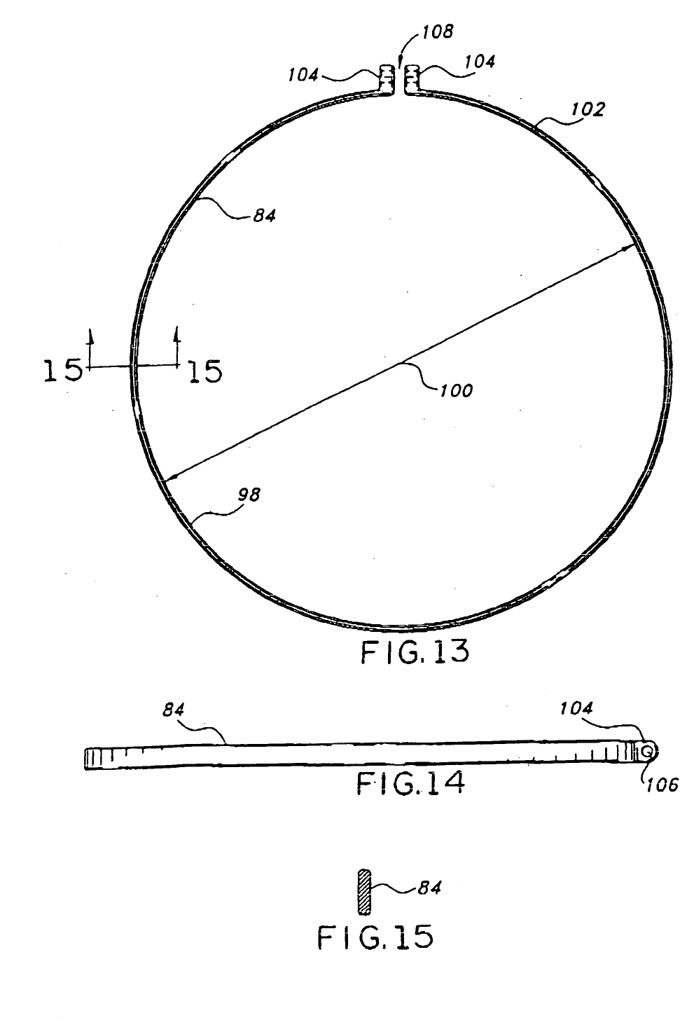

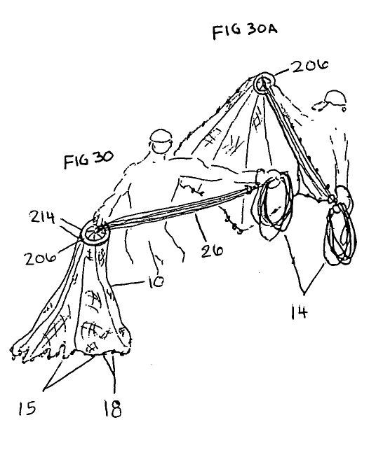

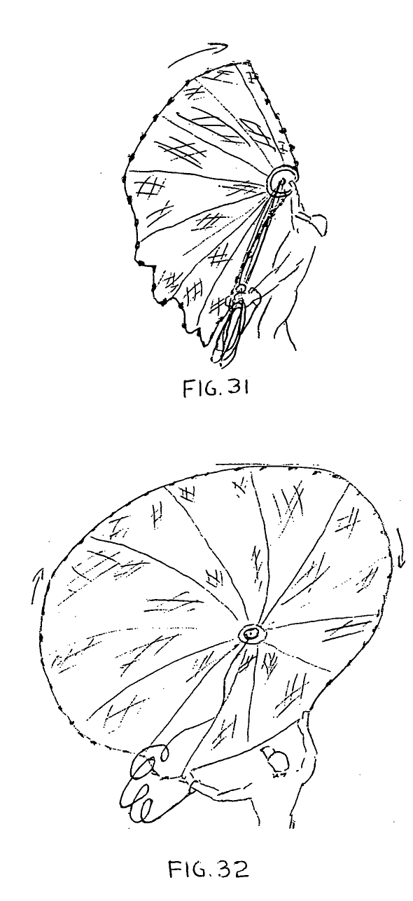

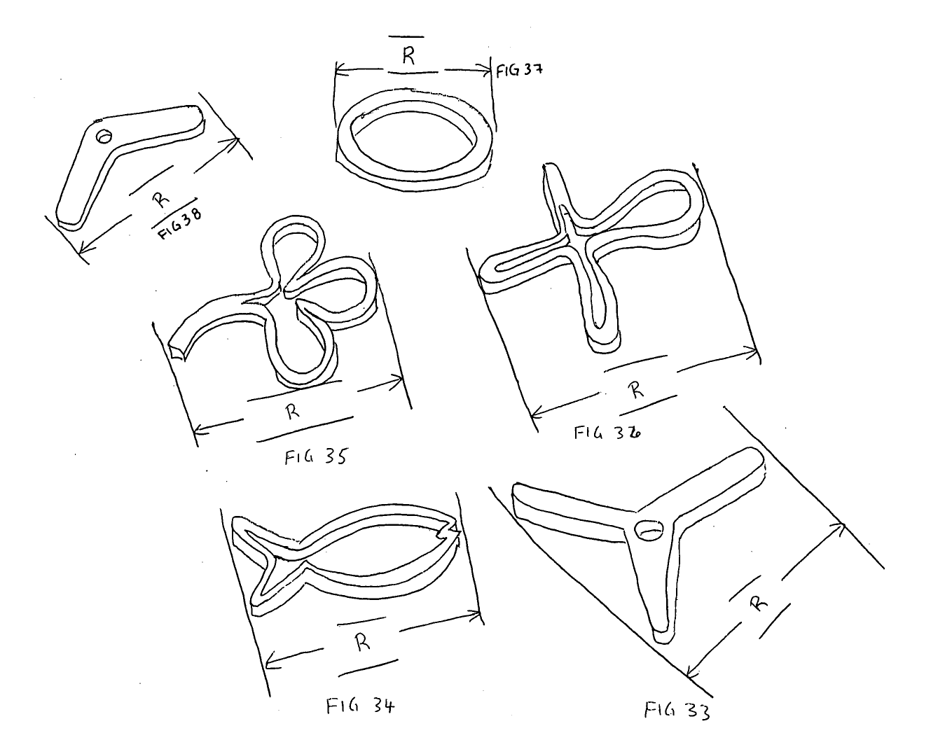

As is stated above, ring type throwing handles are preferred because they most evenly distribute the centrifugal forces generated with minimal stress on the mesh 12 of cast net 10 for use in this invention. Examples of additional embodiments that are useful in this invention are illustrated in FIGS. 6-40.

FIG. 3 is an exploded assembly, perspective view illustrating a cast net throwing device 50, according to a first embodiment of the present invention, and a portion of the previously discussed cast net 10. As shown in FIG. 3, the cast net throwing device 50 includes a handle member comprising a ring member 52 and also includes a binding material 54. The ring member 52 is secured to the netting 12 of the cast net 10 with binding material 54, as subsequently discussed and as illustrated in FIGS. 4 and 5. FIGS. 6 and 7 further illustrate the ring member 52. Ring member 52 includes a radial inner surface 56 which defines an inside diameter 58 which is greater than, and preferably substantially greater than, the outside diameter 64 of the annular thimble 20 of cast net 10. Ring member 52 further includes a radial outer surface 60 defining an annular channel 62 as best seen in the cross-sectional view illustrated in FIG. 7. The radial outer surface 60 also defines an outside diameter 64 and ring member 52 includes a radial height 66 corresponding to the difference between the outside diameter 64 and the inside diameter 58 of ring member 52. In one embodiment, the inventor has observed that the cast net throwing device 50 may be advantageously used with cast nets having a wide range of diameters, with ring member 52 having an outside diameter 64 of about ten inches, a radial height 66 of about one half inch, and an inside diameter 58 of about nine inches. However, the particular values of outside diameter 64, radial height 66 and inside diameter 58 may vary within the scope of the present invention and the foregoing illustrative values of these features are provided as an illustrative example and should not be construed to limit the scope of the present invention. The inventor has further determined that a minimum value for the inside diameter 58 of ring member 52 may be about five inches on smaller nets so that a fisherman may comfortably grasp the ring member 52. Additionally, the maximum value of the outside diameter 64 may vary greatly, provided that the difference between the diameter of the cast net 10 and the outside diameter 64 of ring member 52 is sufficiently large to permit proper closing of the net 10, i.e. that there is sufficient netting material disposed between ring member 52 and lead line 15. In view of the foregoing, it may be appreciated that the overall size and configuration of the ring member 52 permits a fisherman to easily grasp ring member 52 which significantly enhances the fisherman's ability to impart rotation via a mechanical advantage to the cast net 10, so as to facilitate the opening of cast net 10, during a cast. As may be appreciated, ring member 52 is significantly larger than the annular thimble 20 of cast net 10, which typically has an outside diameter of about one and one half inches for instance and is not sufficiently large enough to provide a mechanical advantages as to facilitate the opening of cast net 10 when cast net 10 is thrown; and thimble 20 is not necessary when ring member 228 of FIG. 29d is integrated with cast net 10 because ring member 228 contains apertures throughwhich brail lines 26 must pass making thimble 20 unnecessary.

In the illustrative embodiment, ring member 52 comprises a split ring member having opposing circumferentially facing ends disposed in abutting relationship with one another and defining an interface 68 there between, as best seen in FIG. 6. The cast net throwing device 50 further includes an arcuate connecting member 70 disposed in abutting relationship with the radial inner surface 56 of ring member 52. Furthermore, the arcuate connecting member 70 extends circumferentially on either side of the interface 68 of ring member 52, thereby strengthening ring member 52 and preventing the circumferentially facing ends of ring member 52 from separating. In the illustrative embodiment, connecting member 70 is attached to ring member 52 via a plurality of rivets 72. However, connecting member 70 may be attached to ring member 52 by other conventional fasteners or alternatively may be welded, brazed or otherwise bonded to ring member 52. Additionally, connecting member 70 may comprise an arcuate channel member which is fixedly attached to ring member 52 as shown in FIGS. 6 and 7. Although ring member 52 comprises a split-ring member in the illustrative embodiment, ring member 52 may alternatively comprise a circumferentially continuous ring member. In this event, the connecting member 70 may be omitted.

The binding material 54 may comprise twine, braided thread or rope, or the like, made of various materials, which are suitable for securing the ring member 52 to the netting 12 of cast net 10. In one preferred embodiment, ring member 52 may be made of aluminum. However, ring member 52 may alternatively be made of other metals, metallic alloys, plastic materials or composite materials provided the overall size and configuration of ring member 52 in combination with the material selected permits ring member 52 and net 10 to sink below the surface of the body of water upon which the device is cast (either fresh or salt water) and the material is strong enough to withstand the centrifugal forces acting on ring member 52, when ring member 52 should be water resistant and should substantially retain its characteristics when exposed to fresh or salt water. The buoyancy of the throwing device must be such that it does not sink faster than the lead line.

The cast net throwing device 50 is suitable for retrofitting to an existing cast net 10 as illustrated in FIGS. 3-5 and as subsequently discussed. The ring member 52 is disposed above an upper surface of the netting 12 of cast net 10, with the throw line 44 being passed through ring member 52 as shown in FIG. 3. This position is important to note since it allows ring member 52 to be secured to the netting 12 of cast net 10, without pinching the brail lines 26 and allowing brail lines 26 to be disposed within the interior of ring member 5: ring member 52 cannot be easily installed by positioning ring member 52 below the netting 12 of cast net 10 without allowing for a method to allow the brail lines 26 to enter the center of member 52. Ring member 52 is then disposed in substantially concentric relationship with the annular thimble 20 of cast net 10, which substantially centers the ring member 52 on cast net 10. An annular portion of the netting 12, which is disposed radial outwardly of the thimble 20 is secured within the annular groove 62 of the ring member 52, preferably substantially around the entire periphery of ring member 52 with binding material 54. The binding material 54 is wrapped around the netting 12 disposed within the annular channel 62, is shown in FIG. 5, with opposite ends of the binding material being tied or otherwise secured to one another which secures the ring member 52 to the netting 12 of cast net 10. The binding material 54 does not interfere with brail lines 26. FIG. 4 is a perspective view and FIG. 5 is a cross-sectional view illustrating ring member 52 secured to the netting 12 of cast net 10.

The inventor has determined that a fixture (not shown in FIG. 3), which may comprise a common household device such as a five gallon bucket, may significantly facilitate the operations required to secure ring member 52 to the netting 12 of cast net 10. For instance, the inventor has found it useful to position such a fixture on a work surface and then to place ring member 52 against the fixture, with the cast net 10 draped over the ring member 52. This corresponds to the ring member 52 and cast net 10 being rotated 180 degrees from the position shown in FIG. 3. In this position, the brail lines 26 of cast net 10 are exposed and the netting 12 of cast net 10 is effectively draped over the annular groove 62 providing easy access for installing binding material 54 thereby securing ring member 52 to the netting 12 of cast net 10.

It should be further understood that, although cast net throwing device 50 may be used to retrofit existing cast nets such as cast net 10, the cast net throwing device 50 may alternatively be provided as part of a new cast net. This also applies to the remaining, subsequently discussed embodiments of the cast net throwing device according to the present invention.

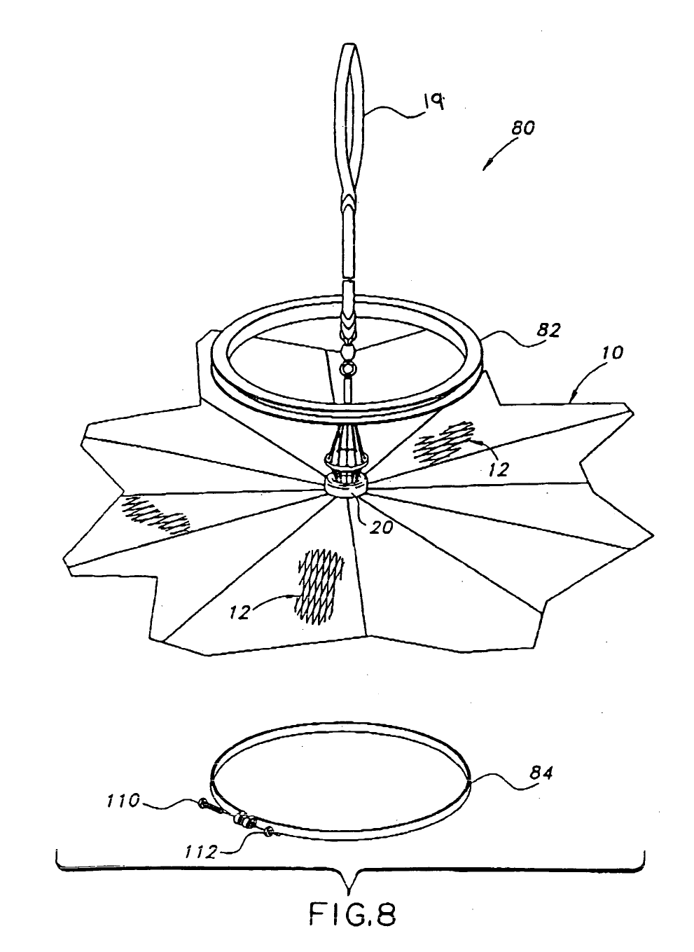

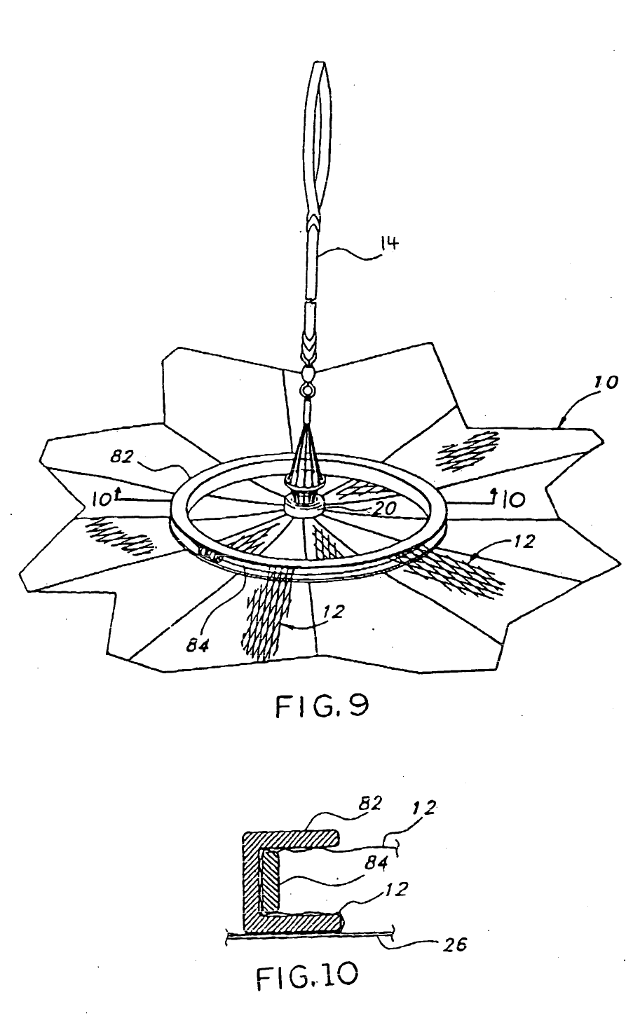

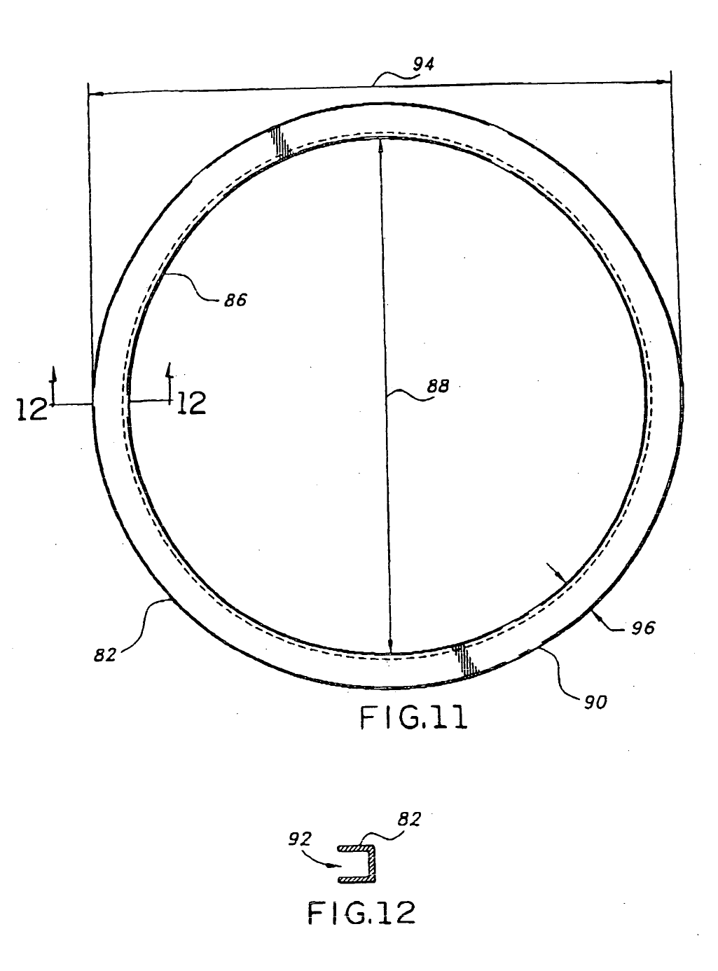

FIG. 8 is an exploded assembly, perspective view illustrating a cast throwing device 80, according to a second embodiment of the present invention, and a portion of the previously discussed cast net 10. As shown in FIG. 8, the cast net throwing device 80 includes a handle member comprising a first ring member 82, which is a circumferentially continuous ring member. Cast net throwing device 80 further includes a second ring member 84, comprising a split ring, clamping member. FIGS. 9 and 10 illustrate the cast net throwing device 80 secured to the netting 12 of the cast net 10, while FIGS. 11-12 further illustrate the ring member 82 and FIGS. 13-15 further illustrate the ring member 84.

As best seen in FIG. 11, ring member 82 includes a radial inner surface 86 defining an inside diameter 88 of ring member 82, and further includes a radial outer surface 90 which defines an annular channel 92, as best seen in FIG. 12. The radial outer surface 90 also defines an outside diameter 94 of ring member 82. Ring member 82 further includes radial height 96 which comprises the difference between the outside diameter 94 and the inside diameter 88 of ring member 82. Inside diameter 88 and outside diameter 94 of ring member 82, as well as the radial height 96 of ring member 82 may have sizes similar to those discussed previously with respect to ring member 52 of cast net throwing device 50. In one preferred embodiment, ring member 82 may be made of a glass fill nylon material, such as thirty-percent glass filled nylon material. However, ring member 82 may alternatively be made of any of the materials of construction discussed in conjunction with ring member 52, provided the material is sufficiently strong to withstand the centrifugal forces acting on ring member 82 and provided that ring member 82 and net 10 may sink below the surface of a body of water (either fresh or salt water) when ring member 82 is secured to cast net 10. Additionally any alternative material for ring member 82 should be water resistant and should substantially retain its characteristics when exposed to fresh or salt water.

Referring to FIGS. 11-15 the split-ring, clamping member 84 has a radial inner surface 98 which defines an inside diameter 100 which is sufficiently large to permit the clamping member 84 to be disposed within the annular channel 92 of ring member 82. The split-ring, clamping member 84 further includes a radial outer surface 102 and first and second circumferentially facing ends, each defining a radial extending flange 104 having an aperture 106 extending there through. The flanges 104 are separated by a gap 108, when the split ring, clamping member 84 is in free state condition as shown in FIG. 13. The split ring, clamping member 84 may be made of the same material as discussed previously with respect to ring member 82 of the cast net throwing device 80.

The cast net throwing device 80 may be secured to the netting 12 of the cast net 10 by passing the throw line 14 through ring member 82 and positioning ring member 84 proximate the top side of net 10 as shown in FIG. 8. A substantially annular portion of the netting 12, which is disposed radial outwardly from the thimble 20 of cast net 10 is then forced into the annular channel 92 of ring member 82, preferably substantially around the entire periphery of ring member 82. The split ring clamping member 84 is then disposed within the annular channel 92, radial outwardly from the netting 12, with the radial extending flanges 104 of clamping member 84 being secured to one another by conventional fasteners such as bolt 110 and nut 112 shown in FIG. 8. A fixture such as a five gallon bucket, (not shown) may be used to facilitate securing cast net throwing device 80 to the netting 12 of cast net 10 in a manner similar to that discussed previously with respect to cast net throwing device 50.

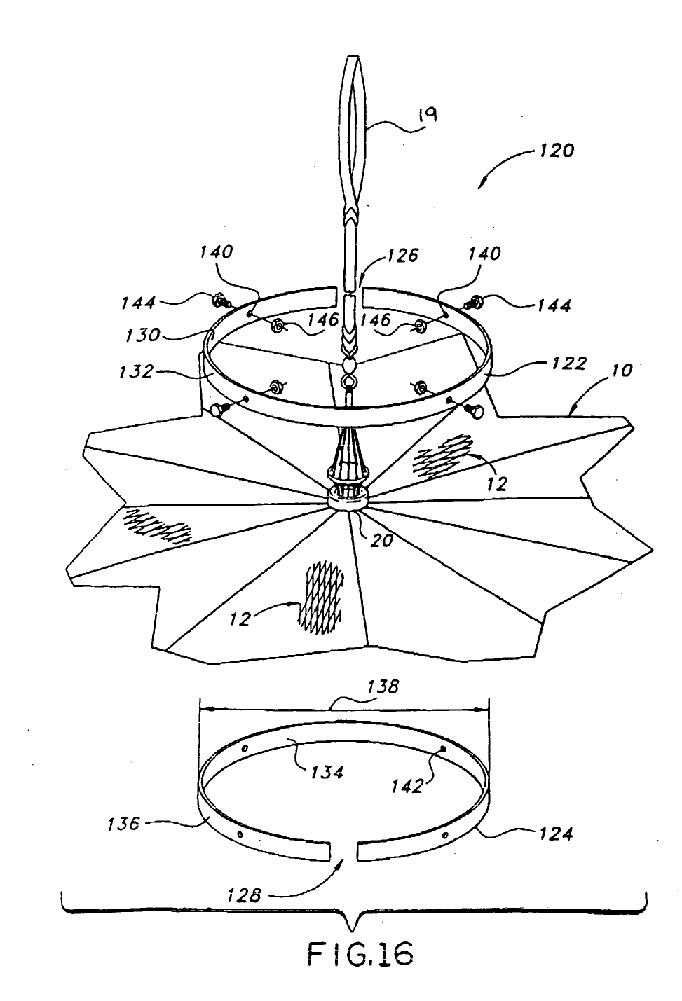

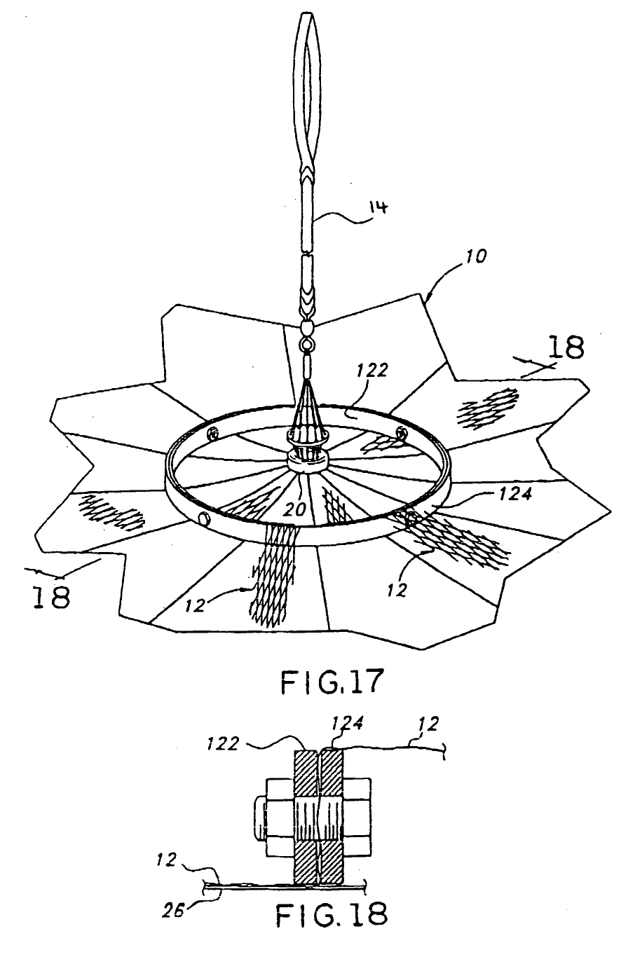

FIG. 16 is an exploded assembly, perspective view illustrating a cast net throwing device 120, and a portion of the previously discussed cast net 10. As shown in FIG. 16, the cast net throwing device 120 includes two components comprising a first ring member 122 and a second ring member 124. Ring members 122 and 124 are secured to one another and to the netting 12 of the cast net 10 as subsequently discussed, and as illustrated in FIGS. 17 and 18. As shown in FIG. 16, each of the ring members 122 and 124 comprise split-ring members having circumferentially facing ends which are separated by gaps 126 and 128, respectively. As shown in FIG. 16, ring member 124 may be installed from the underneath side of netting 12 of cast net 10. Ring member 124 may be so positioned because of gap 128 which is effective for permitting the brail lines 26 of the cast net 10 to pass into the interior ring 124, so that the operation of the brail lines 26 will not be impeded when ring members 122 and 124 are secured to cast net 10.

Ring member 122 includes a radial inner surface 130 defining an inside diameter and a radial outer surface 132 defining an outside diameter. Similarly, ring member 124 includes a radial inner surface 134 defining an inside diameter of ring member 124 and a radial outer surface 136 defining an outside diameter 138 of ring member 124. Ring member 122 includes a plurality of circumferentially spaced apertures 140 which may comprise substantially round holes and are effective for receiving fasteners there through. Similarly, ring member 124 includes a plurality of circumferentially spaced apertures 142, which may also comprise substantially round roles. As may be appreciated from FIGS. 16 and 17, ring members 122 and 124 are very similar in construction. However, ring member 122 is slightly smaller than ring member 124. For instance, in one embodiment, the inside diameter of the ring member 124 is substantially the same as the outside diameter of ring member 122 so that ring member 122 may be nested within ring member 124 when the cast net throwing device is secured to the netting 12 of cast net 10 but will permit a substantially annular portion of the netting 12 to be securely captured between ring members 122 and 124.

In one embodiment, ring members 122 and 124 are formed from aluminum bar stock material. However, ring members 122 and 124 may be made of other metals, metallic alloys, plastic materials or composite materials provided that the use of the alternate materials results in ring members 122 and 124 having sufficient strength and permitting ring members 122 and 124 and net 10 to sink when members 122 and 124 are secured to cast net 10, as discussed with regard to the previous embodiments of the present invention. Additionally, any alternative material for ring members 122 and 124 should be water resistant and should substantially retain its characteristics when exposed to fresh or salt water. Ring members 122 and 124 may have diametrical sizes which are comparable with the size of ring member 52 discussed previously.

The cast net throwing device 120 is secured to cast net 10 as subsequently discussed, and this operation may be facilitated by use of a fixture if desired as discussed previously. The ring member 122 can be positioned against the upper surface of the netting 12 of cast net 10, while ring member 124 can be aligned with ring member 122 and positioned against the underneath surface of the netting 12. Preferably, both ring members 122 and 124 are substantially concentrically disposed with respect to the thimble 20 of cast net 10 which substantially centers ring members 122 and 124 on net 10. Additionally, one of the ring members 122 and 124 is rotated required to align the apertures 140 in ring member 122 with the apertures 142 of ring member 124. Force is then exerted on one of ring members 122 and 124 so that ring member 124 is disposed radial outwardly of ring member 122. The nesting of ring member 122 within ring member 124 is facilitated since each of the members 122 and 124 comprises a split ring member. The shearing action of this operation forces a substantially annular portion of the netting 12 which is disposed radial outwardly of thimble 20 between ring members 122 and 124, thereby capturing this portion of the netting 12 between the radial inner surface 134 of ring member 124 and the radial outer surface 132 of ring member 122. The ring members 122 and 124 are then secured to one another by conventional fasteners, such as bolts 144 which pass through the aligned holes 140 in ring member 122 and holes 142 in ring members 124, and nuts 146 which secure the bolts 144 in position. Alternatively, holes 140 and 142 may comprise tapped holes and bolts 144 may be replaced with sheet metal screws, with nuts 146 being omitted. In the installed position, both ring members 122 and 124 are disposed in surrounding relationship with thimble 20 of cast net 10. Although the positioning of ring members 122 and 124 may be as shown in FIGS. 16-18, the positioning of ring member 122 and 124 may be reversed so that ring member 122 may be installed from the underneath side of netting 12 of cast net 10.

As shown in FIG. 18, brail lines 26 are not captured between ring members 122 and 124. Accordingly, the operation of brail lines 26 is not impeded when the cast net throwing device 120 is secured to the netting 12 of cast net 10. Also, with regard to the substantially annular portion of netting 12 which is captured between ring member 122 and 24, it may be appreciated that this portion of the netting 12 is displaced from the thimble 20 by a radial distance which is sufficiently large that the netting 12 may be forced between ring member 122 and 124.

The above description and related drawings illustrate a plurality of embodiments for ring type throwing handles for use with this invention. The illustrated and described ring type throwing handles have been independent of the thimble assembly, however the thimble may integrated within the design possibilities of the handle to reduce costs of material and/or labor: this is an integral part of the concept of this invention.

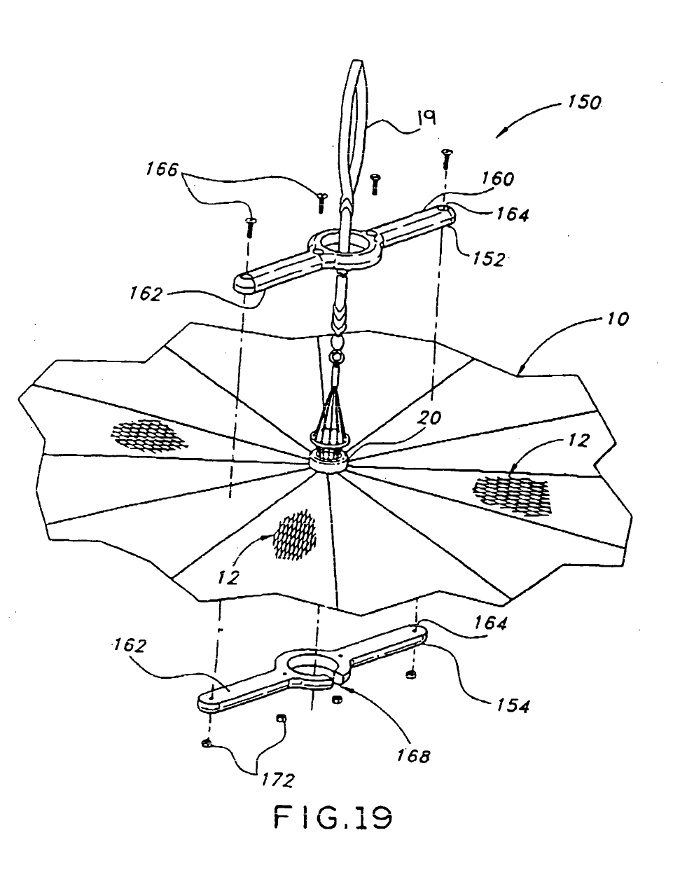

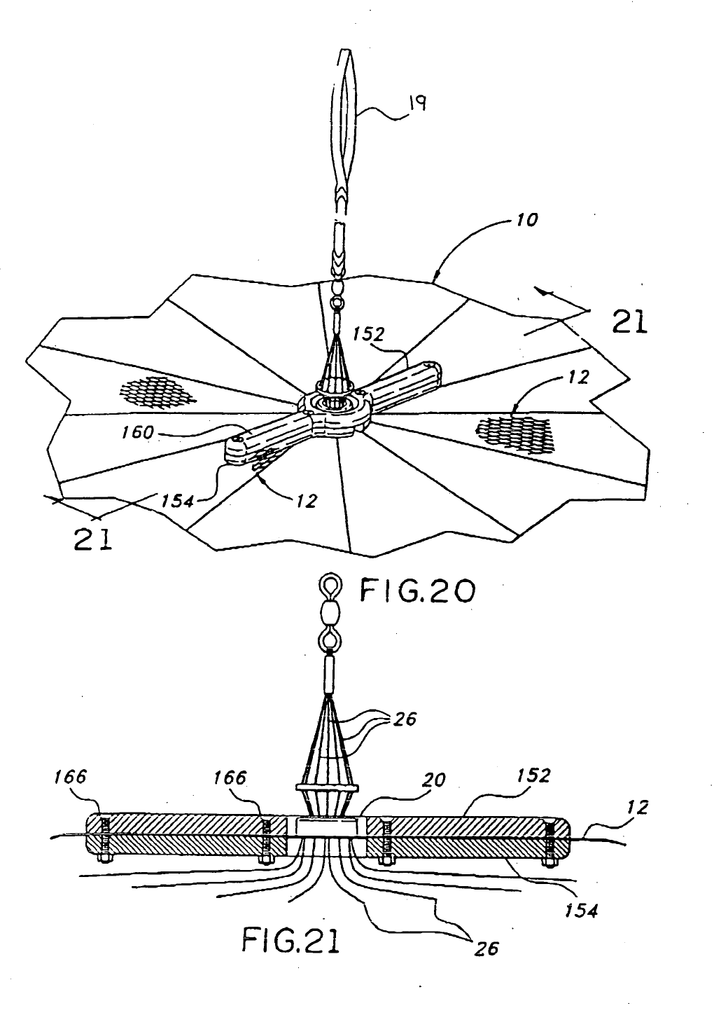

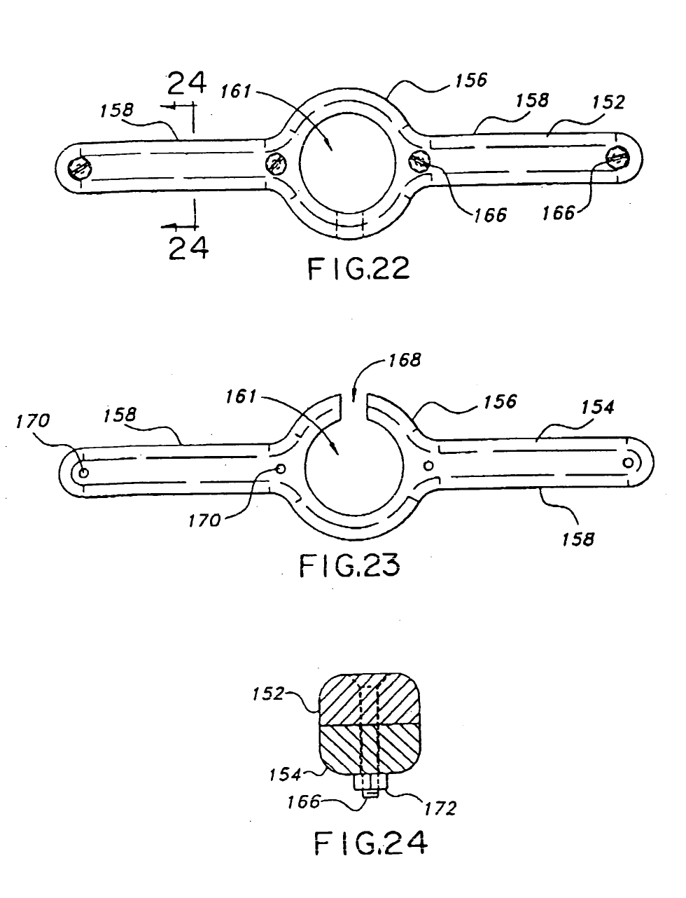

FIG. 19 illustrates another embodiment for a throwing handle which does not incorporate a ring type structure. As can be seen from FIG. 19, which is an exploded assembly, perspective view illustrating a cast net throwing device 150, according to a fourth embodiment for use in the present invention and a portion of the previously discussed cast net 10. As shown in FIG. 19, the cast net throwing device 150 includes two handle members comprising a first elongate member 152 and a second elongated member 154. Members 152 and 154 are secured to the netting 12 of cast net 10 as subsequently discussed and as illustrated in FIGS. 20 and 21. FIG. 22 is a top plan view further illustrating cast net throwing device 150 and FIG. 23 is a bottom plan view further illustrating elongated member 154. In FIG. 24 is a cross-sectioned view further illustrating members 152 and 154 may include additional elongated portions 158 provided members 152 and 154 have a like number of portions 158 and they are similarly positioned. For instance, by way of illustration and not of limitation, each of the elongated members 152 and 154 may have four substantially equally spaced elongated portions 158 so that members 152 and 154 are generally S-shaped. Each of the elongated portions 158 have a longitudinal length extending from a proximal end of portion 158 which is integral with the central ring portion 156 to a distal end of portion 158 which is sized to permit a user to comfortably grasp one of the elongated portions 158 of member 152 and the mating elongated portion 158 of member 154. Accordingly the longitudinal length of each of the elongated portions 158 may have a minimum value ranging from about three inches to about five inches. Elongated members 152 and 154 may be made of any of the materials of construction discussed previously with respect to cast net throwing device 50.

The central ring portion 156 of each member 152 and 154 defines a substantially circular aperture 161 extending there through. The aperture 161 of member 152 is effective for receiving the throw line 14 there through, as well as thimble 20, disk 32 and the portion of the brail lines 26 proximate swivel member 36, as shown in FIGS. 19 and 20. The elongate member 152 includes a first surface 160 having a transverse shape which includes arcuate and substantially flat portions as shown in FIG. 24 and a substantially flat, second surface 162. The elongate member 152 further includes a plurality of apertures 164 extending there through, with the apertures 164 including a countersunk portion proximate surface 160, for the purpose for receiving the head of a fastener, such as screw or bolt 166. Elongate member 154 is preferably the same as elongate member 152 with the following exceptions. The central ring portion 156 of elongate member 154 includes a slot 168 extending there through, with slot 168 communicating with the aperture 161 extending through member 154. The presence of slot 168 and aperture 161 permits elongate member 154 to be disposed proximate the underneath surface of the netting 12 of cast net 10, since the brail lines 26 of net 10 may be passed through slot 168 and into aperture 161. Accordingly, when the cast net throwing device 150 is secured to cast net 10, the operation of the brail lines 26 is not impeded as best seen in FIG. 21. Another difference between members 152 and 154 is that the member 154 includes a plurality of aperture 170, which preferably comprise straight through clearance holes, in lieu of the apertures 164 of member 152 which include a countersunk portion.

Cast net throwing device 150 is secured to the netting 12 of cast net 10 as follows. Members 152 and 154 are disposed with the substantially flat surface 162 of both of the members 152 and 154 facing the netting 12 of cast net 10. With the elongate member 152 disposed above cast net 10, the throw line 14 is passed through aperture 161 of member 152. Member 152 is then disposed against the upper surface of the netting 12, with the central ring portion 156 being disposed in surrounding relationship with the thimble 20 of the cast net 10. This substantially centers member 152 on cast net 10. The aperture 161 of member 152 is preferably disposed in substantially concentric relationship with the thimble 20 of cast net 10 thereby further facilitating the centering of member 152 on net 10. Member 154 is disposed below cast net 10 and the brail lines 26 are passed through slot 168 into aperture 161 of member 154. Member 154 is then placed against the underneath surface of the netting 12, with the through holes 170 in number 154 being aligned with the apertures 164 extending through member 152. The aperture 161 of member 154 is also disposed in substantially concentric relationship with thimble 20 of net 10. Members 152 and 154 are then secured to one another by bolts 166 and nuts 172. As may be appreciated, the inside diameter of aperture 161 must be greater than the outside diameter of thimble 20 of cast net 10, so that thimble 20 may be disposed within aperture 161 of member 152, as shown in FIGS. 21 and 22. When members 152 and 254 have been secured to one another, a portion of the netting 12 of cast net 10 is captured between members 152 and 154. Unlike the previous embodiments, however, the portion of the netting 12 to which the cast net throwing device 150 is secured, does not comprise a substantially annular portion of the netting 12, but instead comprises portion of netting 12 conforming generally to the shape of surface 162.

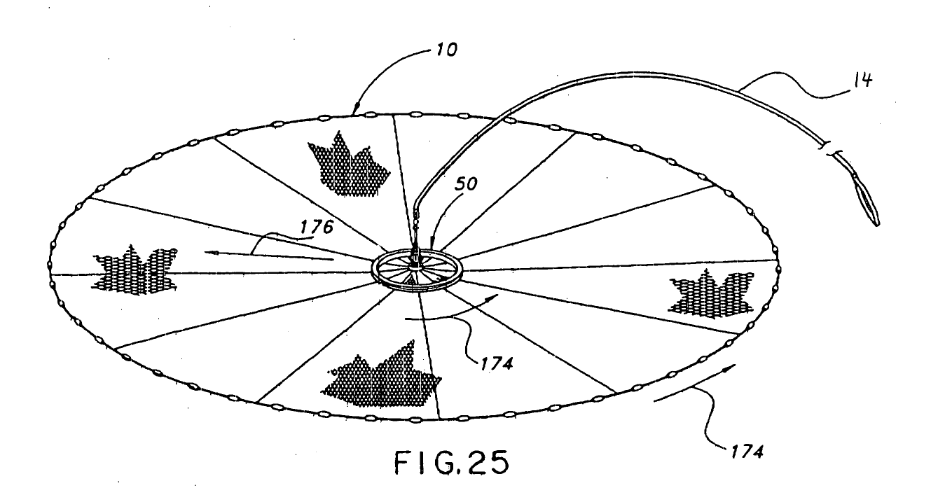

In operation, any of the embodiments of the cast net throwing device according to the present invention significantly enhances the ability to properly cast or throw cast net 10, as subsequently discussed in conjunction with cast net throwing device 50 and FIG. 25. After the cast net throwing device 50 has been secured to cast net 10, the fisherman may grasp the cast net throwing device 50 with one hand, along with the throw line 44. The inventor has determined that it is then useful for the fisherman to grasp a portion of the lead line 15 which corresponds generally to the same “clock” position that the fisherman is grasping on the cast net throwing device. For instance, if the fisherman grasps the cast net throwing device 50 at approximately the six o'clock position, the inventor has observed that it is useful to grasp a portion of the lead line 15 at approximately the six o'clock position. It is noted that good results may also be achieved by varying the position where lead line 15 is grasped by as much as about plus or minus forty-five degrees. The inventor has further observed that it is then useful to drape the lead line 15 from opposite sides of the fisherman's hand which is holding lead line 15, rope 44 and the cast net throwing device 50. As final preparation, the inventor has observed that it is useful to reposition the portions of lead line 15 which are proximate the location where lead line 15 is being grasped, over the top of the cast net throwing device 50. Inventor has also notice that when using throwing device 228 of FIG. 29d that user may draw a portion of the brail lines up through the apertures 227 within ring 228 to shorten the distance that the leadline 15 is able to swing away from the ring 228; thereby, enabling the user to easily throw nets with a radius larger than his height. The fisherman may then turn in a complete or partial circle thereby imparting rotation to the cast net throwing device 50 or 228 and the cast net 10 as shown by rotation arrows 174 in FIG. 25. The resulting centrifugal forces, depicted by arrow 176 in FIG. 25, facilitate the opening of the cast net 10 during the cast. Since the throwing device 50 is substantially centered on net 10. The inventor has determined that grasping the included handle member or members of the cast net throwing device according to the present invention, provides a mechanical advantage and significantly increases the user's ability to spin or sling the cast net during the act of throwing the cast net, thereby creating centrifugal force which is great enough to cause the entire lead line of the cast net to rotate in a circular motion, thereby causing the cast net to open as it pulls away from the user's body upon release.

In this regard, the inventor has observed that use of a cast net throwing device results in greater net rotation during a throwing process, as compared to conventional nets which do not incorporate the cast net throwing device. The added radius of the cast net throwing device provides the user with an effective torque converter whereby the user is able to impart additional velocity to the rotation lead line 15.

In the throwing process the users starts an initial rotating motion about his body during the final few degrees of this initial rotation the user flips his wrist in a Frisbee-like or a disc-like motion, depending upon his chosen over-handed or under-handed grip. This wrist flipping effect further accentuates the mechanical advantage of the throwing device and applies additional force to lead line 15, which is already in motion. This additional force dramatically increased the lead line velocity, resulting in a cast net throw that opens easier, faster, and with greater centrifugal force.

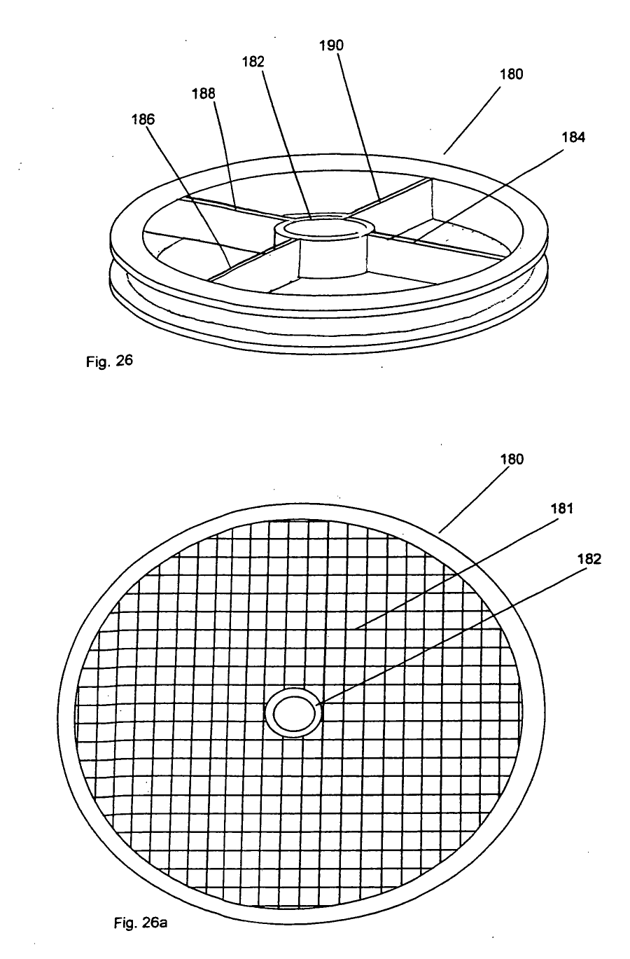

Suitable throwing devices can assume a variety of embodiments as are shown in FIG. 26 to 29e and 33 to 40.

The exact position where a particular throwing device is placed on cast net 10 can be determined by one skilled in the art by trial and error. As is discussed above the throwing device should be positioned in such a manner that it does not interfere with the function of the brail lines.

The basic requirements for throwing devices which may be attached to cast nets, in accordance with this invention, is that they must facilitate the direct transfer of muscular energy, through the hand of the user, to the weights of the lead line, with a mechanical advantage. The mechanical advantage imparted to the cast net, by a given throwing device, is proportional to the distance between the gripping point on the throwing device and the furthermost point opposite the gripping point on the throwing device. Generally it could be said that the greater the distance between the gripping point on the throwing device and the further most point of attachment, to cast net 10, opposite gripping point, the greater the mechanical advantage. It is desirable to locate the throwing device, on cast net 10, as close as possible to the center of the net without interfering with the function of the brail lines.

From the above description it can be seen that the throwing device is essentially evenly placed about the central portion of the cast net. The throwing device should extend radially outward at least about one half inch per radius foot, away from the center of the net, and up to about 33% percent of the distance between the thimble and the lead line away from the center of the net, a more preferred range is from about four inches to about 12 inches outward from the center of the net, with a most preferred range being from about 5 inches to about 8 inches from the center of the net. The most preferred placement of the throwing device on the net portion depends on the nature and structure of the particular throwing device utilized.

As is discussed above a preferred embodiment for the throwing device is a ring wherein the diameter of the ring is from about one inch per radius foot of the cast net to about 33% percent of the diameter of the cast net, a more preferred range is from about eight inches to about 24 inches, with a most preferred range being from about ten inches to about 16 inches. A most preferred size, for a throwing device which is a ring, for a net having a radius of from about 3 to about 6 feet is about 10 to 12 inches, and for nets with a radius of from about 7 to 12 feet is about 12 to 16 inches.

The mechanical advantage of the throwing device of this invention is determined by the two further most points on the throwing device. The cast net throwing device has an effective mechanical advantage when the distance between the two further most points on the throwing device is about 1″ per radius foot of the cast net or greater. The distance between the two further most points on the throwing device should be no greater than 66% of the radius of the cast net.

As can be seen from FIG. 26 the throwing device 180 may further incorporate an integral thimble 182. A preferred structure is shown wherein both the throwing device and the thimble are circular. In this embodiment the diameter of the thimble 182 can be about one to three and a half inches and the diameter of the throwing device 180 from about one inch per radius foot of the cast net to about 66% of the radius of the cast net and may be supported by for example a plurality of spokes 184, 186, 188, and 190. FIG. 26a is an alternate design of throwing device 180 containing a grid 181 which may secure integral thimble 182.

A most preferred size for a throwing device in accordance with this embodiment, for cast nets having a radius of from about 8 to 12 feet is about ten inches to about 16 inches and for cast nets having a radius of about three feet to seven feet from about eight inches to about twelve inches. The integral thimble having a most preferred diameter of about one and a half inches to about three and a half inches and an aperture of about one inch to about three inches.

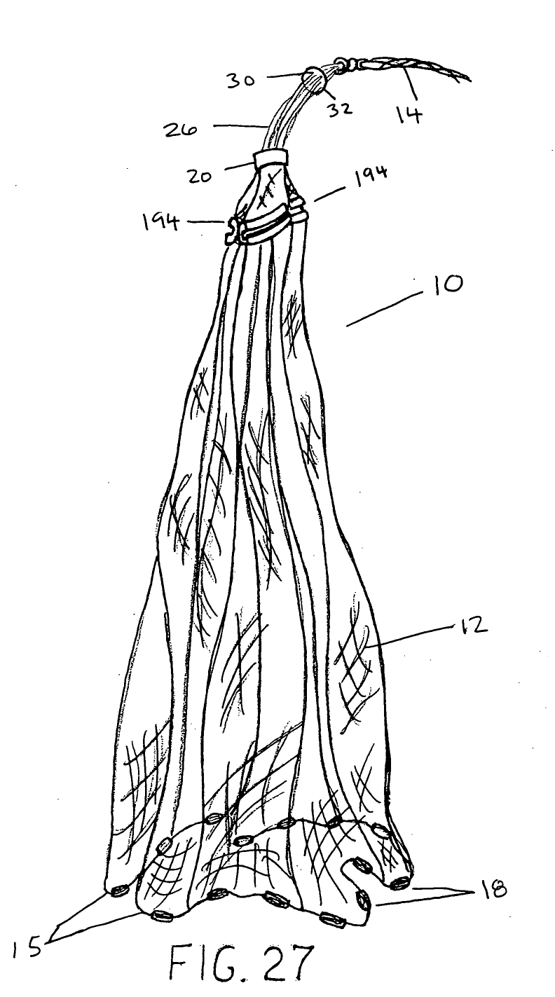

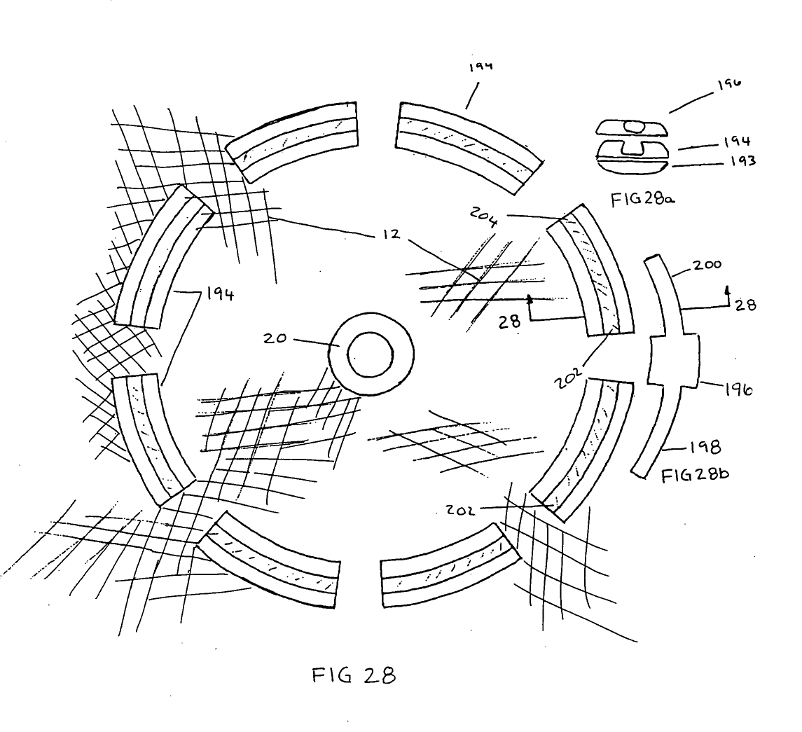

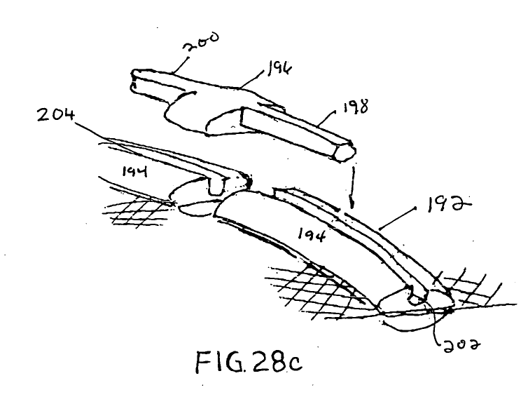

Multi component throwing devices are within the purview of this invention. A suitable multi-component throwing ring is shown in FIGS. 27 to 28c. FIG. 28 shows a cast net 10 having unassembled pieces 194 attached thereto. As can be seen from FIG. 28b handle 192 is formed from a plurality of segments 194 and 196 that can be easily assembled after purchase; the composite assembly occupies minimal retail shelf space and reduces shipping volume.

As can be seen in FIG. 28 to 28b adjacent segments can be locked together by use of locking block 196 which incorporates locking arms 198 and 200. These locking arms are locked into grooves 202 and 204 which are integral with segments 194. If desired grooves 202 and 204 and locking arms 198 and 200 may incorporate opposing tapers such that once assembled throw ring 192 cannot be disassembled.

FIGS. 29 and 29a illustrate another embodiment of this invention. In this embodiment, apertures 214 along the periphery of the multi-component throwing device 206 are provided. Brail lines 26 pass through these apertures. This embodiment enables the user to shorten the distance between the center of rotation about the users body and the leadline 15 by pulling the brail lines 26 through the apertures 214 formed within the throwing device 206. In this embodiment, cast net throwing device 206 comprises two sections 208 and 210 which may be secured to cast net 10 via fasteners 212 or through any other process known in the art. When ring sections 208 and 210 are assembled together, apertures 214 are formed. Apertures 214 are of such a size that brail lines 26 can pass freely there through. The number of apertures 214 within assembled throwing device 206 should equal to the number of brail lines; however, for a general purpose after-market throwing device, 24 apertures 214 is preferred as this will retrofit the majority of cast nets currently marketed.

As is shown in FIGS. 30 and 30a, during the throwing process, brail lines 26 can be drawn up through apertures 214 so as to effectively shorten the composite net structure for the throwing process. For example with this procedure a 12 ft. net can be shortened up to the size of a six-foot net for the throwing procedure.

This procedure constitutes a new process for throwing a cast net with a radius larger than the user's height using only one hand.

The angler should grasp throwing ring 228 as seen in FIG. 29d with the finger tips of his throwing hand (i.e. knuckles on top, palm facing ring 228); coil excess rope 14, pull a desired length of the brail lines 26 through the apertures 227 sufficient to reduce the distance that the leadline 15 can swing away from the ring 228 to an amount that will allow easy casting of cast net 10 and hold in place along side coiled up slack from rope 14. Then take a portion of the leadline 15 that corresponds to the position being grasped by the throwing hand on the ring 228 (i.e. if grasping the 4:00 position of the ring 228, go radially outward to the 4:00 position of the leadline 15) and place that portion of the leadline 15 in between the throwing hand and the gripped position of the ring 228, laying the skirt of the net just over the edge of the ring 228. Accelerate rotation in the direction of the thumb of the throwing hand for 230 degrees to 270 degrees allowing throwing hand to pull away from body and palm to become approximately parallel with the horizon; release grip from ring 228, leadline, 15 and rope 14 to allow net 10 to swirl into an open configuration.

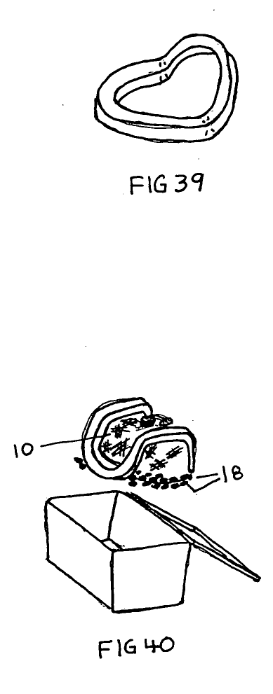

Various throwing device can be formed from a wide variety of materials, aluminum is an excellent material from which the throwing device of this invention, as aluminum is easily formed, durable, inexpensive, and corrosion resistant. The throwing device can be further formed from a wide variety of reinforced and un-reinforced polymeric material. Further the throwing device can be formed from flexible materials such as flexible polymeric materials. If flexible materials are utilized they should be somewhat rigid in order to prevent their collapse during the throwing process. As seen in FIGS. 39 and 40, the ability of a throwing device to flex is useful in the storage of the cast net of this invention, as the throwing device can be made to deform to a storage container.

While the foregoing description has set forth the preferred embodiments of the present invention in particular detail, it must be understood that numerous modifications, substitutions and changes can be undertaken without departing from the true spirit and scope of the present invention as defined by the ensuring claims. For instance, the cast net throwing device according to the present invention may include one or more handle members having a wide variety of shapes and configurations other than those of the ring or elongate members included in the embodiments disclosed herein, and the handle member or members may be secured to the netting of the cast net differently than as shown in the embodiments illustrated herein, provided: the handle member or members are sized and configured to allow the user to easily grasp the member or members thereby enhancing the user's ability to impart rotation to the cast net during the act of casting the net; the handle member or members of the cast net throwing device are substantially centered on the cast net to which the device is secured; the handle member or members are constructed of water resistant materials which include, but are not limited to, aluminum, stainless steel, other metals and metallic alloys, glass filled nylon such as thirty percent glass filled nylon, plastic materials, composite materials, rubbers and the like that will substantially retain their characteristics under wet or salty conditions and are sufficiently strong to withstand the centrifugal forces acting upon the cast net throwing device during the act of casting, the handle member to be secured to the netting of the cast net in such a manner that the handle member or members remain secured to the netting during the act of casting; the cast net throwing device does not prohibit the passing of the brail lines of the cast net to which the device is secured and does not otherwise prevent closing of the cast net; and the cast net throwing device and cast net may sink after impact with the surface of water, when the cast net throwing device is secured to the cast net. The invention is therefore not limited to specific preferred embodiments as described, but is limited only as defined by the following claims.

What is claimed is:

1. An improved cast net having a circular net portion, a lead line which circumscribes the periphery of the circular net portion, a thimble which is located approximate the center of the circular net position, a throw line, and a plurality of brail lines which pass through the thimble, one terminal end of each brail line being attached to the lead line, the other terminal end of each of the brail lines being attached to a terminal end of the throw line, wherein the improvement comprises:
attaching at least one handle to the net portion intermediate of the lead line and the thimble, the handle being somewhat centrally disposed in relation to the lead line, wherein when said handle is gripped, the cast net may be rotated and thrown and wherein the placement of the handle is such that the brail lines pass freely through apertures within said handle and remain functional.

2. The improved cast net of claim 1 wherein said handle has a mechanical advantage.

3. The improved cast net of claim 1 wherein the handle is a ring with apertures for receiving brail lines.

4. The improved ring of claim 1 wherein the handle is a ring with apertures for receiving brail lines and has a groove around its periphery for attachment to a cast net.

5. The improved ring of claim 3 wherein the handle is a ring with apertures for receiving brail lines and has a groove around its periphery for attaching to a cast net and is made of plastic.

6. The improved cast net of claim 2 wherein the handle is a ring with apertures for receiving brail lines.

7. The improved ring of claim 2 wherein the handle is a ring with apertures for receiving brail lines and has a groove around its periphery for attachment to a cast net.

8. The improved ring of claim 2 wherein the handle is a ring with apertures for receiving brail lines and has a groove around its periphery for attaching to a cast net and is made of plastic.

9. A process for throwing a cast net with one hand comprising of the steps of;
a. providing cast net having a circular net portion, a lead line which circumscribes the periphery of the circular net portion having a center, a throw line, and a plurality of brail lines, one terminal end of each brail line being attached to the lead line, the other terminal end of each of the brail line being attached to a terminal end of the throw line, attaching a throwing device to the net portion intermediate of the lead line and the center, herein the periphery of the throwing device incorporates a plurality of apertures through which the brail lines pass,
b. slipping the throw line around the throwing wrist,
c. looping the throw line into a loose coil and grasping said throw line with the hand to which the throw line is connected,
d. gripping the cast net throwing device with the throwing hand,
e. placing a portion of the lead line that is radially outward from the gripping position upon the handle in between the grip of the throwing hand and the handle,
f. drawing a length of the brail lines up through the handle sufficient to limit the swinging distance of the leadline from exceeding the desired distance, and holding such a position upon the brail lines in the throwing hand,
g. rotating in the direction of the thumb of the throwing hand, accelerating for between 230 degrees and 270 degrees allowing hand to be pulled away from torso area with underside of cast net generally parallel with the horizon, and releasing grip on throwing device and cast net parts simultaneously in the direction of the intended target.
